(19) United States
(12) Patent Application Publication
(10) Pub. No.: US 2024/0013052 A1
(43) Pub. Date: Jan. 11, 2024

(54) Bit Sparse Neural Network Optimization

(71) Applicant: Arm Limited, Cambridge (GB)

(72) Inventors: Zhi-Gang Liu, Westford, MA (US); Paul Nicholas Whatmough, Cambridge, MA (US); John Fremont Brown, III, Marion, MA (US)

(73) Assignee: Arm Limited, Cambridge (GB)

(21) Appl. No.: 17/861,824

(22) Filed: Jul. 11, 2022

(51) Int. Cl. G06N 3/08

(52) U.S. Cl. CPC G06N 3/082

(57) ABSTRACT

A method, system and apparatus provide bit-sparse neural network optimization. Rather than quantizing and pruning weight and activation elements at the word level, weight and activation elements are pruned at the bit level, which reduces the density of effective “set” bits in weight and activation data, which, advantageously, reduces the power consumption of the neural network inference process by reducing the degree of bit-level switching during inference.

### BACKGROUND

The present disclosure relates to computer systems. More particularly, the present disclosure relates to machine learning and neural network systems.

Machine learning in general, and deep learning in particular, such as deep neural networks (DNNs), convolutional neural networks (CNNs), etc., are popular solutions to a wide array of challenging classification, recognition and regression problems. However, many artificial neural networks (ANN) models require a large number of calculations involving a large number of weights and activations, which presents a significant challenge with respect to access, storage and performance, particularly for mobile and other power or storage-constrained devices.

To execute deep learning inference workloads more efficiently, neural network models may be quantized and pruned at the granularity of the element values of the weight and/or activation data (i.e., at the word level). For example, during neural network training, weight values may be quantized from floating point (or higher-precision integer) to 8-bit integer, and then pruned to 50% sparsity (i.e., 50% of the weight values are set to zero). A similar approach may be applied to activation values during neural network training, which requires dynamic quantization and pruning of the activation values during inference.

Unfortunately, lower bit-width quantization (e.g., integers less than 8-bits) and higher-sparsity word-level pruning (e.g., greater than 50% sparsity) undesirably decreases inference accuracy.

### BRIEF DESCRIPTION OF THE DRAWINGS

FIG. 1 depicts an ANN, in accordance with embodiments of the present disclosure.

FIG. 2 depicts a CNN, in accordance with embodiments of the present disclosure.

FIG. 3A depicts convolutional layer calculation for a CNN, FIG. 3B depicts a converted convolutional layer calculation for a CNN, and FIG. 3C depicts a converted input data matrix, in accordance with an embodiment of the present disclosure.

FIG. 4 depicts a data flow diagram for a multiply-and-accumulate (MAC) array.

FIG. 5 depicts a power consumption contour graph, in accordance with an embodiment of the present disclosure.

FIG. 6 depicts a bit-pruning unit (BPU), in accordance with an embodiment of the present disclosure.

FIGS. 7A to 7L depict the generation of the mask of the first set bit for different input data values, in accordance with an embodiment of the present disclosure.

FIG. 8 depicts parallel prefix logic to generate the mask of the first set bit, in accordance with an embodiment of the present disclosure.

FIGS. 9A to 9L depict the generation of the mask of the first set bit for different input data values, in accordance with an embodiment of the present disclosure.

FIG. 10 depicts a block diagram of system, in accordance with an embodiment of the present disclosure.

### DETAILED DESCRIPTION

Embodiments of the present disclosure will now be described with reference to the drawing figures, in which like reference numerals refer to like parts throughout.

Embodiments of the present disclosure address quantization and pruning of neural network data from a novel perspective. Instead of conventional quantization and pruning at the weight or activation element level (i.e., the word level), embodiments of the present disclosure advantageously prune the bits of each weight and activation element (i.e., the bit level), which reduces the density of effective “set” bits in weight and activation data, which, advantageously, reduces the power consumption of the neural network inference process by reducing the degree of bit-level switching during inference.

Generally, weight data are quantized and “bit-pruned” during neural network training and the resulting weights are used during inference. In many embodiments, activation data are quantized and bit-pruned during neural network training, and then dynamically quantized and bit-pruned during inference. Embodiments of the present disclosure also provide a bit-pruning unit (BPU) to dynamically prune activation data during inference.

In one embodiment, a method includes training a neural network, based on training data, to generate a trained neural network, the neural network including weights, the training including quantizing the weights to generate quantized weights, each quantized weight including a number of bits set to 1, and pruning, based on the number of bits set to 1, the quantized weights to generate bit-pruned weights, each bit pruned weight including a smaller number of bits set to 1 than the respective quantized weight, where the trained neural network includes the bit-pruned weights.

An ANN models the relationships between input data or signals and output data or signals using a network of interconnected nodes that is trained through a learning process. The nodes are arranged into various layers, including, for example, an input layer, one or more hidden layers, and an output layer. The input layer receives input data, such as, for example, image data, and the output layer generates output data, such as, for example, a probability that the image data contains a known object. Each hidden layer provides at least a partial transformation of the input data to the output data. A DNN has multiple hidden layers in order to model complex, nonlinear relationships between input data and output data.

In a fully-connected, feedforward ANN, each node is connected to all of the nodes in the preceding layer, as well as to all of the nodes in the subsequent layer. For example, each input layer node is connected to each hidden layer node, each hidden layer node is connected to each input layer node and each output layer node, and each output layer node is connected to each hidden layer node. Additional hidden layers are similarly interconnected. Each connection has a weight value, and each node has an activation function, such as, for example, a linear function, a step function, a sigmoid function, a tanh function, a rectified linear unit (ReLU) function, etc., that determines the output of the node based on the weighted sum of the inputs to the node. The input data propagates from the input layer nodes, through respective connection weights to the hidden layer nodes, and then through respective connection weights to the output layer nodes.

More particularly, at each input node, input data is provided to the activation function for that node, and the output of the activation function is then provided as an input data value to each hidden layer node. At each hidden layer node, the input data value received from each input layer node is multiplied by a respective connection weight, and the resulting products are summed or accumulated into an activation value that is provided to the activation function for that node. The output of the activation function is then provided as an input data value to each output layer node. At each output layer node, the output data value received from each hidden layer node is multiplied by a respective connection weight, and the resulting products are summed or accumulated into an activation value that is provided to the activation function for that node. The output of the activation function is then provided as output data. Additional hidden layers may be similarly configured to process data.

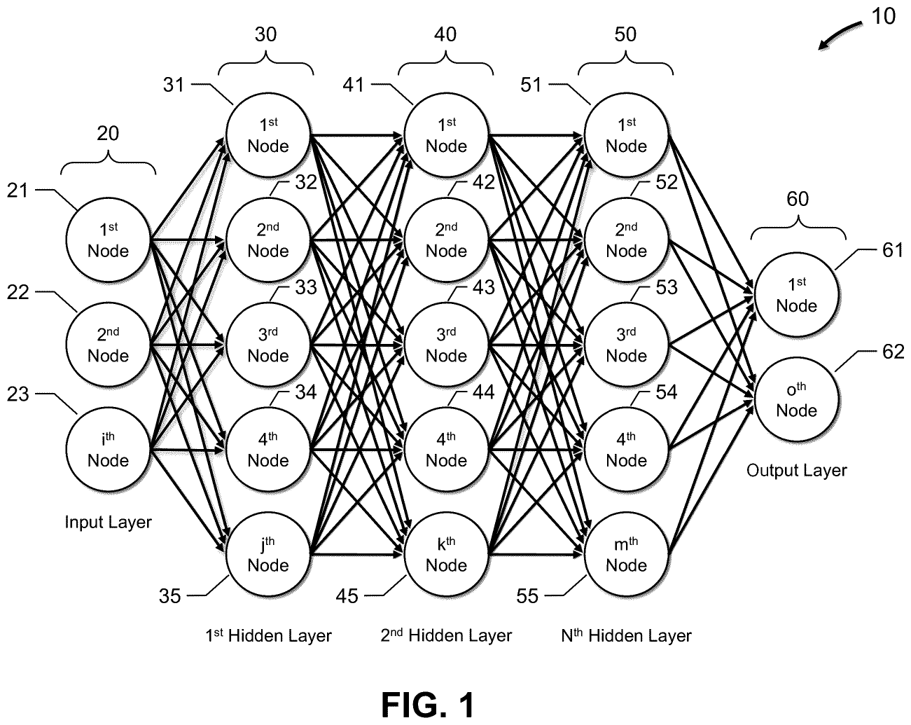

FIG. 1 depicts ANN 10, in accordance with an embodiment of the present disclosure.

ANN 10 includes input layer 20, one or more hidden layers 30, 40, 50, etc., and output layer 60. Input layer 20 includes one or more input nodes 21, 22, 23, etc. Hidden layer 30 includes one or more hidden nodes 31, 32, 33, 34, 35, etc. Hidden layer 40 includes one or more hidden nodes 41, 42, 43, 44, 45, etc. Hidden layer 50 includes one or more hidden nodes 51, 52, 53, 54, 55, etc. Output layer 60 includes one or more output nodes 61, 62, etc. Generally, ANN 10 includes N hidden layers, input layer 20 includes “i” nodes, hidden layer 30 includes “j” nodes, hidden layer 40 includes “k” nodes, hidden layer 50 includes “m” nodes, and output layer 60 includes “o” nodes.

In one embodiment, N equals 3, i equals 3, j, k and m equal 5 and o equals 2 (depicted in FIG. 1). Input node 21 is coupled to hidden nodes 31 to 35, input node 22 is coupled to hidden nodes 31 to 35, and input node 23 is coupled to hidden nodes 31 to 35. Hidden node 31 is coupled to hidden nodes 41 to 45, hidden node 32 is coupled to hidden nodes 41 to 45, hidden node 33 is coupled to hidden nodes 41 to 45, hidden node 34 is coupled to hidden nodes 41 to 45, and hidden node 35 is coupled to hidden nodes 41 to 45. Hidden node 41 is coupled to hidden nodes 51 to 55, hidden node 42 is coupled to hidden nodes 51 to 55, hidden node 43 is coupled to hidden nodes 51 to 55, hidden node 44 is coupled to hidden nodes 51 to 55, and hidden node 45 is coupled to hidden nodes 51 to 55. Hidden node 51 is coupled to output nodes 61 and 62, hidden node 52 is coupled to output nodes 61 and 62, hidden node 53 is coupled to output nodes 61 and 62, hidden node 54 is coupled to output nodes 61 and 62, and hidden node 55 is coupled to output nodes 61 and 62.

Many other variations of input, hidden and output layers are clearly possible, including hidden layers that are locally-connected, rather than fully-connected, to one another.

Training an ANN includes optimizing the connection weights between nodes by minimizing the prediction error of the output data until the ANN achieves a particular level of accuracy. One method is backpropagation, or backward propagation of errors, which iteratively and recursively determines a gradient descent with respect to the connection weights, and then adjusts the connection weights to improve the performance of the network.

A multi-layer perceptron (MLP) is a fully-connected ANN that has an input layer, an output layer and one or more hidden layers. MLPs may be used for natural language processing applications, such as machine translation, speech recognition, etc. Other ANNs include recurrent neural networks (RNNs), long short-term memories (LSTMs), sequence-to-sequence models that include an encoder RNN and a decoder RNN, shallow neural networks, etc.

A CNN is a variation of an MLP that may be used for classification or recognition applications, such as image recognition, speech recognition, etc. A CNN has an input layer, an output layer and multiple hidden layers including convolutional layers, pooling layers, normalization layers, fully-connected layers, etc. Each convolutional layer applies a sliding dot product or cross-correlation to an input volume, applies an activation function to the results, and then provides the activation or output volume to the next layer. Convolutional layers typically use the ReLU function as the activation function. In certain embodiments, the activation function is provided in a separate activation layer, such as, for example, a ReLU layer. A pooling layer reduces the dimensions of the output volume received from the preceding convolutional layer, and may calculate an average or a maximum over small clusters of data, such as, for example, 2×2 matrices. In certain embodiments, a convolutional layer and a pooling layer may form a single layer of a CNN. The fully-connected layers follow the convolutional and pooling layers, and include a flatten layer and a classification layer, followed by a normalization layer that includes a normalization function, such as the SoftMax function. The output layer follows the last fully-connected layer; in certain embodiments, the output layer may include the normalization function.

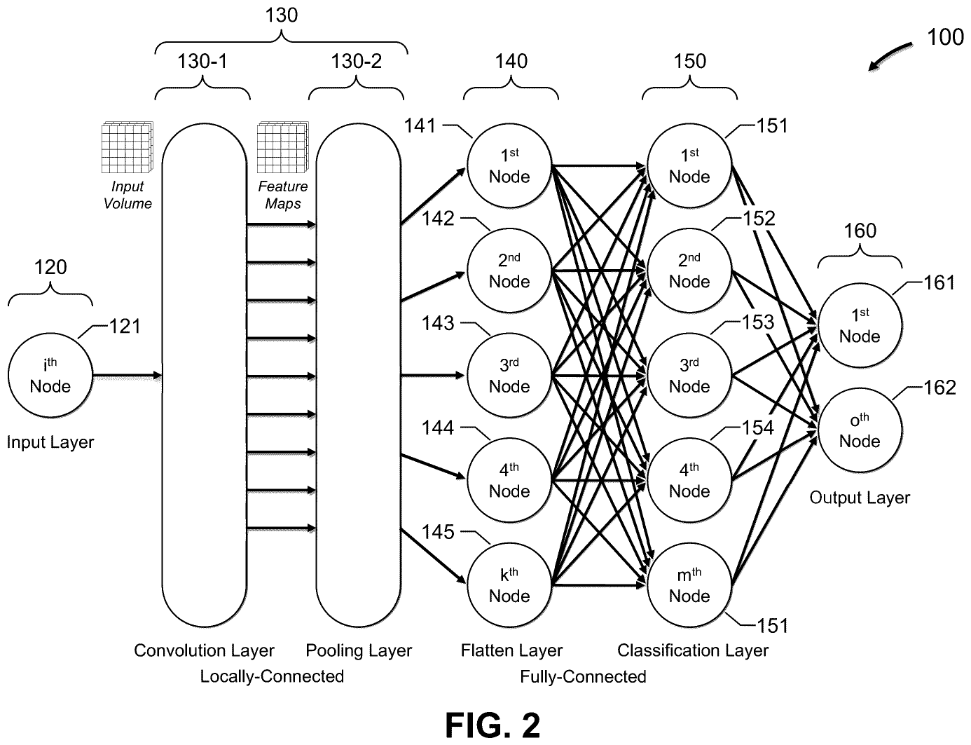

FIG. 2 depicts CNN 100, in accordance with an embodiment of the present disclosure. CNN 100 includes input layer 120, one or more hidden layers, such as convolutional layer 130-1, pooling layer 130-2, hidden (flatten) layer 140, hidden (classification) layer 150, etc., and output layer 160. Many other variations of input, hidden and output layers are contemplated.

Input layer 120 includes one or more input nodes 121, etc., that present the input data, such as a color image, as an input volume to the first convolutional layer, e.g., convolutional layer 130-1. The input volume is a three-dimensional matrix that has a height (1^{st} dimension or number of rows), a width (2^{nd} dimension or number of columns) and a depth (3^{rd} dimension). For example, input data that represent a color image are presented as an input volume that is 512 pixels×512 pixel×3 channels (red, green, blue); other input volume dimensions may also be used, such as 32×32×3, 64×64×3, 128×128×3, etc., 32×32×1, 64×64×1, 128×128×1, 512×512×1, etc.

Convolutional layer 130-1 is locally-connected to input layer 120, and includes a plurality of nodes that are connected to local regions in the input volume (not depicted for clarity). For a CNN that uses a standard convolution, each node computes a dot product between the node's weights and the respective local region of the input volume. An activation function is then applied to the results of each convolution calculation to produce an output volume that is provided as an input volume to the subsequent layer. The activation function may be applied by each convolutional layer node or by the nodes of a subsequent locally-connected ReLU layer.

Pooling layer 130-2 is locally-connected to convolutional layer 130-1, and includes a plurality of nodes that are connected to local regions in the input volume (not depicted for clarity). Pooling layer 130-2 also produces an output volume that is provided as the input volume to the subsequent layer, such as, for example, another convolutional layer 130-1, a flatten layer 140, etc. In certain embodiments, convolutional layer 130-1 and pooling layer 130-2 form a single hidden layer 130. Similarly, in certain embodiments, convolutional layer 130-1, a ReLU layer and pooling layer 130-2 form a single hidden layer 130. Generally, the output volumes of the convolutional and pooling layers may be described as feature maps, and one or more single hidden layers 130 form a feature learning portion of CNN 100.

Hidden layer 140 is a “flatten” layer that is locally-connected to pooling layer 130-2, and includes one or more hidden (flatten) nodes 141, 142, 143, 144, 145, etc. Hidden (flatten) layer 140 “flattens” the output volume produced by the preceding pooling layer 130-2 into a column vector, which is provided to the subsequent, fully-connected hidden layer 150.

Hidden layer 150 is a classification layer that is fully-connected to hidden (flatten) layer 140, and includes one or more hidden (classification) nodes 151, 152, 153, 154, 155, etc.

Output layer 160 includes one or more output nodes 161, 162, etc., and is fully-connected to hidden (classification) layer 150. Fully-connected output layer 160 receives the classification results output by hidden (classification) layer 150, and each node outputs a predicted class score. A normalization function, such as a SoftMax function, may be applied to the predicted class scores by output layer 160, or, alternatively, by an additional layer interposed between hidden (classification) layer 150 and output layer 160.

Similar to ANNs, training a CNN includes optimizing the connection weights between nodes by minimizing the prediction error of the output data until the CNN achieves a particular level of accuracy. As noted above, backpropagation may be used to iteratively and recursively determines a gradient descent with respect to the connection weights, and then adjusts the connection weights to improve the performance of the network. Matrix multiplication operations, and, more particularly, multiply-and-accumulate (MAC) operations, are used extensively by CNNs, as well as other ANNs.

Typically, native convolution operations are not performed by a CNN due to the complicated dataflow and expensive datapaths that are usually required. Instead, native convolution operations are converted into generic matrix multiplication (GEMM) operations, and then the GEMM operations are executed more efficiently using optimized software libraries for a processor or specialized hardware, such as, for example, a matrix multiply accelerator (MMA), a neural processing unit (NPU), a graphics processing unit (GPU), a digital signal processor (DSP), etc.

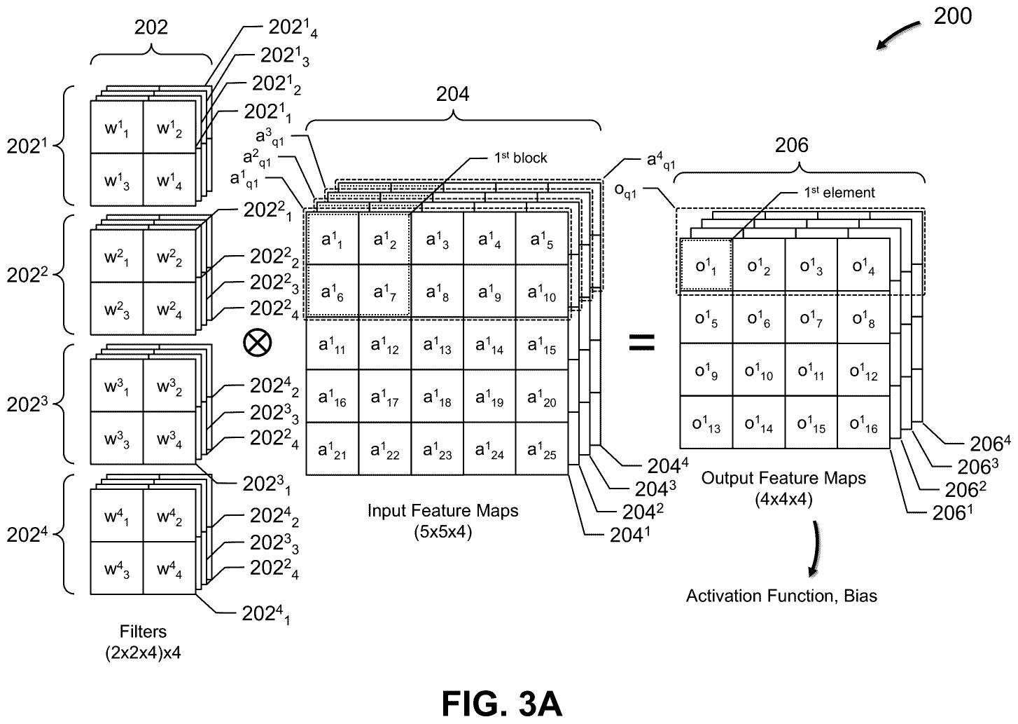

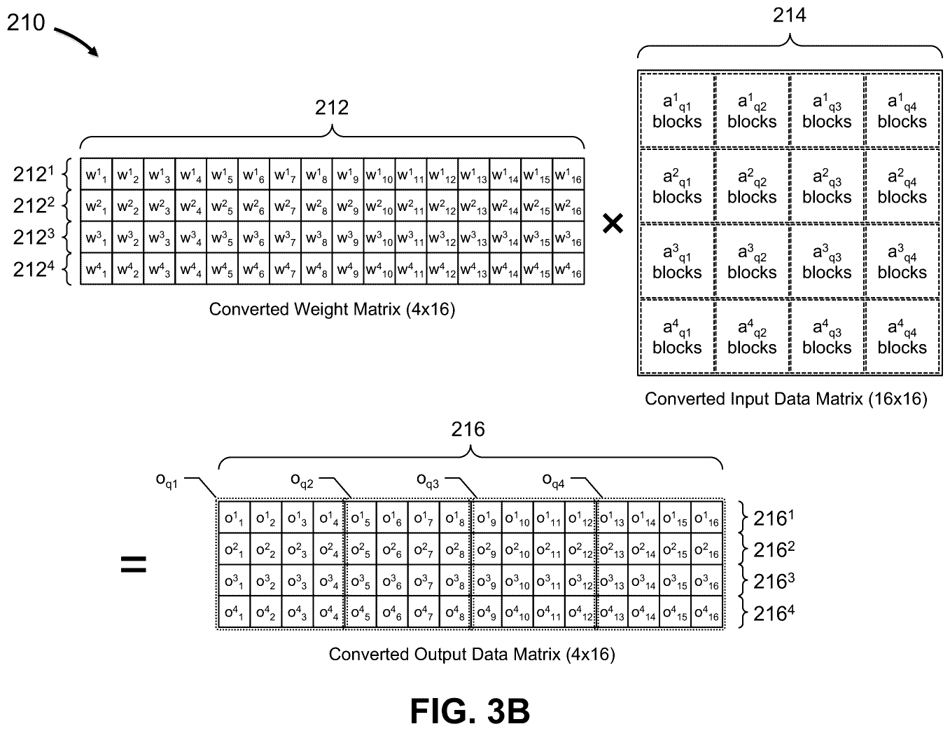

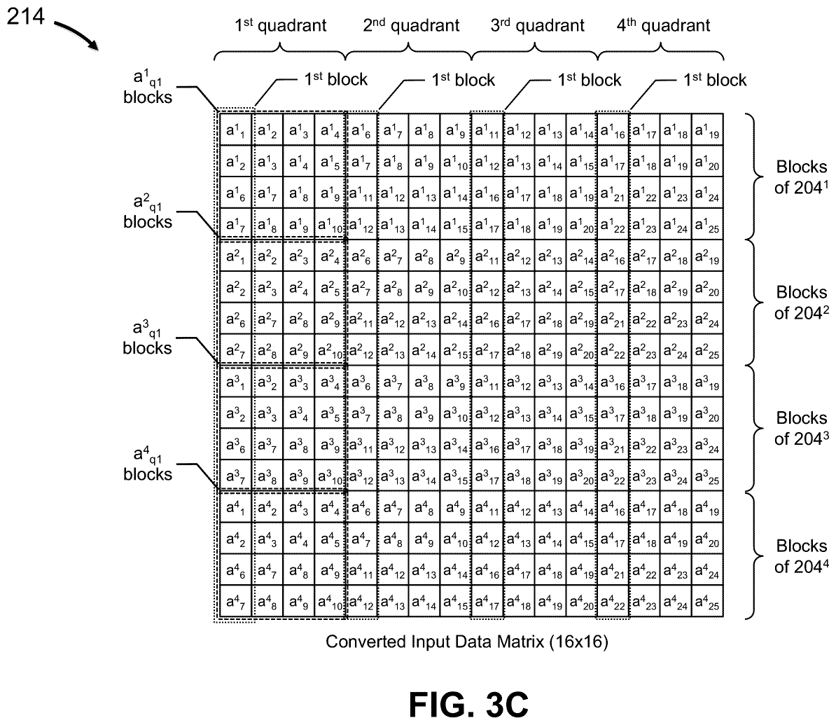

FIG. 3A depicts convolutional layer calculation 200 for a CNN, in accordance with an embodiment of the present disclosure.

Input feature maps 204 include four channels and one input data matrix for each channel, i.e., input data matrices 204¹, 204², 204³ and 204⁴. Filter 202 includes four filter or weight sets 202¹, 202², 202³ and 202⁴, and each filter or weight set includes four weight matrices, one weight matrix for each channel. Output feature maps 206 include four channels and one output data matrix for each filter or weight set, i.e., output data matrices 206¹, 206², 206³ and 206⁴. Convolutional layer calculation 200 convolves filter 202 with input feature maps 204 to produce output feature maps 206.

Generally, input data matrices 204¹, 204², 204³ and 204⁴ form an input tensor, each weight set 202¹, 202², 202³ and 202⁴ forms a weight tensor, and output data matrices 206¹, 206², 206³ and 206⁴ form an output tensor. In this embodiment, each tensor has a height (1^{st} dimension or number of rows), a width (2^{nd} dimension or number of columns) and a depth (3^{rd} dimension). The depth of the input tensor is equal to the number of channels, the depth of each weight tensor is equal to the number of channels, and the depth of the output tensor is equal to the number of weight tensors (i.e., weight sets). While particular dimensions for the tensors and matrices have been selected for clarity of illustration and explanation, embodiments of the present disclosure are not so limited.

In one embodiment, input data matrix 204¹ is a 5×5 matrix (i.e., 5 rows and 5 columns) associated with the first channel and includes activations a¹₁, a¹₂, a¹₃, a¹₄, a¹₅, a¹₆, a¹₇, a¹₈, a¹₉, a¹₁₀, a¹₁₁, a¹₁₂, a¹₁₃, a¹₁₄, a¹₁₅, a¹₁₆, a¹₁₇, a¹₁₈, a¹₁₉, a¹₂₀, a¹₂₁, a¹₂₂, a¹₂₃, a¹₂₄ and a¹ ₂₅. Input data matrix 204² is a 5×5 matrix associated with the second channel and includes activations a²₁, a²₂, a²₃, a²₄, a²₅, a²₆, a²₇, a²₈, a²₉, a²₁₀, a²₁₁, a²₁₂, a²₁₃, a²₁₄, a²₁₅, a²₁₆, a²₁₇, a²₁₈, a²₁₉, a²₂₀, a²₂₁, a²₂₂, a²₂₃, a²₂₄ and a²₂₅. Input data matrix 204³ is a 5×5 matrix associated with the third channel and includes activations a³₁, a³₂, a³₃, a³₄, a³₅, a³₆, a³₇, a³₈, a³₉, a³₁₀, a³₁₁, a³₁₂, a³₁₃, a³₁₄, a³₁₅, a³₁₆, a³₁₇, a³₁₈, a³₁₉, a³₂₀, a³₂₁, a³₂₂, a³₂₃, a³₂₄ and a³₂₅. Input data matrix 204⁴ is a 5×5 matrix associated with the fourth channel and includes activations a⁴₁, a⁴₂, a⁴₃, a⁴₄, a⁴₅, a⁴₆, a⁴₇, a⁴₈, a⁴₉, a⁴₁₀, a⁴₁₁, a⁴₁₂, a⁴₁₃, a⁴₁₄, a⁴₁₅, a⁴₁₆, a⁴₁₇, a⁴₁₈, a⁴₁₉, a⁴₂₀, a⁴₂₁, a⁴₂₂, a⁴₂₃, a⁴₂₄ and a⁴₂₅.

In this embodiment, weight set 202¹ includes four weight matrices 202¹₁, 202¹₂, 202¹₃ and 202¹₄. Weight matrix 202¹₁ is a 2×2 matrix (i.e., 2 rows and 2 columns) associated with the first channel, and includes weights w¹₁, w¹₂, w¹₃ and w¹₄. Weight matrix 202¹₂ is a 2×2 matrix associated with the second channel, and includes weights w¹₅, w¹₆, w¹₇ and w¹₈. Weight matrix 202¹₃ is a 2×2 matrix associated with the third channel, and includes weights w¹₉, w¹₁₀, w¹₁₁ and w¹₁₂. Weight matrix 202¹₄ is a 2×2 matrix associated with the fourth channel, and includes weights w¹₁₃, w¹₁₄, w¹₁₅ and w¹₁₆.

Weight set 202² includes four weight matrices 202²₁, 202²₂, 202²₃ and 202²₄. Weight matrix 202²₁ is a 2×2 matrix associated with the first channel, and includes weights w²₁, w²₂, w²₃ and w²₄. Weight matrix 202²₂ is a 2×2 matrix associated with the second channel, and includes weights w²₅, w²₆, w²₇ and w²₈. Weight matrix 202²₃ is a 2×2 matrix associated with the third channel, and includes weights w²₉, w²₁₀, w²₁₁ and w²₁₂. Weight matrix 202²₄ is a 2×2 matrix associated with the fourth channel, and includes weights w²₁₃, w²₁₄, w²₁₅ and w²₁₆.

Weight set 202³ includes four weight matrices 202³₁, 202³₂, 202³₃ and 202³₄. Weight matrix 202³₁ is a 2×2 matrix associated with the first channel, and includes weights w³₁, w³₂, w³₃ and w³₄. Weight matrix 202³₂ is a 2×2 matrix associated with the second channel, and includes weights w³₅, w³₆, w³₇ and w³₈. Weight matrix 202³₃ is a 2×2 matrix associated with the third channel, and includes weights w³₉, w³₁₀, w³₁₁ and w³₁₂. Weight matrix 202³₄ is a 2×2 matrix associated with the fourth channel, and includes weights w³₁₃, w³₁₄, w³₁₅ and w³₁₆.

Weight set 202⁴ includes four weight matrices 202⁴₁, 202⁴₂, 202⁴₃ and 202⁴₄. Weight matrix 202⁴₁ is a 2×2 matrix associated with the first channel, and includes weights w⁴₁, w⁴₂, w⁴₃ and w⁴₄. Weight matrix 202⁴₂ is a 2×2 matrix associated with the second channel, and includes weights w⁴₅, w⁴₆, w⁴₇ and w⁴₈. Weight matrix 202⁴₃ is a 2×2 matrix associated with the third channel, and includes weights w⁴₉, w⁴₁₀, w⁴₁₁ and w⁴₁₂. Weight matrix 202⁴₄ is a 2×2 matrix associated with the fourth channel, and includes weights w⁴₁₃, w⁴₁₄, w⁴₁₅ and w⁴₁₆.

In this embodiment, output data matrix 206¹ is a 4×4 matrix associated with weight set 202¹ and includes activations o¹₁, o¹₂, o¹₃, o¹₄, o¹₅, o¹₆, o¹₇, o¹₈, o¹₉, o¹₁₀, o¹₁₁, o¹₁₂, o¹₁₃, o¹₁₄, o¹₁₅ and o¹₁₆. Output data matrix 206² is a 4×4 matrix associated with weight set 202² and includes activations o²₁, o²₂, o²₃, o²₄, o²₅, o²₆, o²₇, o²₈, o²₉, o²₁₀, o²₁₁, o²₁₂, o²₁₃, o²₁₄, o²₁₅ and o²₁₆. Output data matrix 206³ is a 4×4 matrix associated with weight set 202³ and includes activations o³₁, o³₂, o³₃, o³₄, o³₅, o³₆, o³₇, o³₈, o³₉, o³₁₀, o³₁₁, o³₁₂, o³₁₃, o³₁₄, o³₁₅ and o³₁₆. Output data matrix 206⁴ is a 4×4 matrix associated with weight set 202⁴ and includes activations o⁴₁, o⁴₂, o⁴₃, o⁴₄, o⁴₅, o⁴₈, o⁴₇, o⁴₈, o⁴₉, o⁴₁₀, o⁴₁₁, o⁴₁₂, o⁴₁₃, o⁴₁₄, o⁴₁₅ and o⁴₁₆.

For ease of explanation, each input data matrix 204¹, 204², 204³ and 204⁴ may be divided into four quadrants. The first quadrant spans the top (first) row and the second row, the second quadrant spans the second row and the third row, the third quadrant spans the third row and the fourth row, and the fourth quadrant spans the fourth row and the fifth (bottom) row. The first quadrant for input data matrix 204¹ (a¹_{q1}), the first quadrant for input data matrix 204² (a²_{q1}), the first quadrant for input data matrix 204³ (a³_{q1}), and the first quadrant for input data matrix 204⁴ (a⁴_{q1}) are depicted; the remaining three quadrants for each input data matrix are not depicted for clarity.

First quadrant a¹_{q1} includes elements all, a¹₁, a¹₂, a¹₃, a¹₅, a¹₆, a¹₇, a¹₈, a¹₉ and a^{b1}₁₀, from which four blocks of elements are formed, i.e., a first block (a¹₁, a¹₂, a¹₆ and a¹₇), a second block (a¹₂, a¹₃, a¹₇ and a¹₈), a third block (a¹₃, a¹₄, a¹₈ and a¹₉), and a fourth block (a¹₄, a¹₅, a¹₉ and a¹₁₀). First quadrant a²_{q1} includes elements a²₁, a²₂, a²₃, a²₄, a²₅, a²₆, a²₇, a²₈, a²₉ and a²₁₀, from which four blocks of elements are formed, i.e., a first block (a²₁, a²₂, a²₆ and a²₇), a second block (a²₂, a²₃, a²₇ and a²₈), a third block (a²₃, a²₄, a²₈ and a²₉), and a fourth block (a²₄, a²₅, a²₉ and a²₁₀). First quadrant a³_{q1} includes elements a³₁, a³₂, a³₃, a³₄, a³₅, a³₆, a³₇, a³₈, a³₉ and a³₁₀, from which four blocks of elements are formed, i.e., a first block (a³₁, a³₂, a³₆ and a³₇), a second block (a³₂, a³₃, a³₇ and a³₈), a third block (a³₃, a³₄, a³₈ and a³₉), and a fourth block (a³₄, a³₅, a³₉ and a³₁₀). First quadrant a⁴_{q1} includes elements a⁴₁, a⁴₂, a⁴₃, a⁴₄, a⁴₅, a⁴₆, a⁴₇, a⁴₈, a⁴₉ and a⁴₁₀, from which four blocks of elements are formed, i.e., a first block (a⁴₁, a⁴₂, a⁴₆ and a⁴₇), a second block (a⁴₂, a⁴₃, a⁴₇ and a⁴₈), a third block (a⁴₃, a⁴₄, a⁴₈ and a⁴₉), and a fourth block (a⁴₄, a⁴₅, a⁴₉ and a⁴₁₀).

Second quadrant a¹_{q2} includes elements a¹₆, a¹₇, a¹₈, a¹₉, a¹₁₁, a¹₁₂, a¹₁₃, a¹₁₄ and a¹₁₅, from which four blocks of elements are formed, i.e., a first block (a¹₆, a¹₇, a¹₁₁ and a¹₁₂), a second block (a¹₇, a¹₈, a¹₁₂ and a¹₁₃), a third block (a¹₈, a¹₉, a¹₁₃ and a¹₁₄), and a fourth block (a¹₉, a¹₁₀, a¹₁₄ and a¹₁₅). Second quadrant a²_{q2} includes elements a²₆, a²₇, a²₈, a²₉, a²₁₀, a²₁₁, a²₁₂, a²₁₃, a²₁₄ and a²₁₅, from which four blocks of elements are formed, i.e., a first block (a²₆, a²₇, a²₁₁ and a²₁₂), a second block (a²₇, a²₈, a²₁₂ and a²₁₃), a third block (a²₈, a²₉, a²₁₃ and a²₁₄), and a fourth block (a²₉, a²₁₀, a²₁₄ and a²₁₅). Second quadrant a³_{q2} includes elements a³₆, a³₇, a³₈, a³₉, a³₁₀, a³₁₁, a³₁₂, a³₁₃, a³₁₄ and a³₁₅, from which four blocks of elements are formed, i.e., a first block (a³₆, a³₇, a³₁₁ and a³₁₂), a second block (a³₇, a³₈, a³₁₂ and a³₁₃), a third block (a³₈, a³₉, a³₁₃ and a³₁₄), and a fourth block (a³₉, a³₁₀, a³₁₄ and a³₁₅). Second quadrant a⁴_{q2} includes elements a⁴₆, a⁴₇, a⁴₈, a⁴₉, a⁴₁₀, a⁴₁₁, a⁴₁₂, a⁴₁₃, a⁴₁₄ and a⁴₁₅, from which four blocks of elements are formed, i.e., a first block (a⁴₆, a⁴₇, a⁴₁₁ and a⁴₁₂), a second block (a⁴₇, a⁴₈, a⁴₁₂ and a⁴₁₃), a third block (a⁴₈, a⁴₉, a⁴₁₃ and a⁴₁₄), and a fourth block (a⁴₉, a⁴₁₀, a⁴₁₄ and a⁴₁₅).

Third quadrant a¹_{q3} includes elements a¹₁₁, a¹₁₂, a¹₁₃, a¹₁₄, a¹₁₅, a¹₁₆, a¹₁₇, a¹₁₈, a¹₁₉ and a¹₂₀, from which four blocks of elements are formed, i.e., a first block (a¹₁₁, a¹₁₂, a¹₁₆ and a¹₁₇), a second block (a¹₁₂, a¹₁₃, a¹₁₇ and a¹₁₈), a third block (a¹₁₃, a¹₁₄, a¹₁₈ and a¹₁₉), and a fourth block (a¹₁₄, a¹₁₅, a¹₁₉ and a¹₂₀). Third quadrant a²_{q3} includes elements a²₁₁, a²₁₂, a²₁₃, a²₁₄, a²₁₅, a²₁₆, a²₁₇, a²₁₈, a²₁₉ and a²₂₀, from which four blocks of elements are formed, i.e., a first block (a²₁₁, a²₁₂, a²₁₆ and a²₁₇), a second block (a²₁₂, a²₁₃, a²₁₇ and a²₁₈), a third block (a²₁₃, a²₁₄, a²₁₈ and a²₁₉), and a fourth block (a²₁₄, a²₁₅, a²₁₉ and a²₂₀). Third quadrant a³_{q3} includes elements a³₁₁, a³₁₂, a³₁₃, a³₁₄, a³₁₅, a³₁₆, a³₁₇, a³₁₈, a³₁₉ and a³₂₀, from which four blocks of elements are formed, i.e., a first block (a³₁₁, a³₁₂, a³₁₆ and a³₁₇), a second block (a³₁₂, a³₁₃, a³₁₇ and a³₁₈), a third block (a³₁₃, a³₁₄, a³₁₈ and a³₁₉), and a fourth block (a³₁₄, a³₁₅, a³₁₉ and a³₂₀). Third quadrant a⁴_{q3} includes elements a⁴₁₁, a⁴₁₂, a⁴₁₃, a⁴₁₄, a⁴₁₅, a⁴₁₆, a⁴₁₇, a⁴₁₈, a⁴₁₉ and a⁴₂₀, from which four blocks of elements are formed, i.e., a first block (a⁴₁₁, a⁴₁₂, a⁴₁₆ and a⁴₁₇), a second block (a⁴₁₂, a⁴₁₃, a⁴₁₇ and a⁴₁₈), a third block (a⁴₁₃, a⁴₁₄, a⁴₁₈ and a⁴₁₉), and a fourth block (a⁴₁₄, a⁴₁₅, a⁴₁₉ and a⁴₂₀).

Fourth quadrant a¹_{q4} includes elements a¹₁₆, a¹₁₇, a¹₁₈, a¹₁₉, a¹₂₀, a¹₂₁, a¹₂₂, a¹₂₃, a¹₂₄ and a¹₂₅, from which four blocks of elements are formed, i.e., a first block (a¹₁₆, a¹₁₇, a¹₂₁ and a¹₂₂), a second block (a¹₁₇, a¹₁₈, a¹₂₂ and a¹₂₃), a third block (a¹₁₈, a¹₁₉, a¹₂₃ and a¹₂₄), and a fourth block (a¹₁₉, a¹₂₀, a¹₂₄ and a¹₂₅). Fourth quadrant a²_{q4} includes elements a²₁₆, a²₁₇, a²₁₈, a²₁₉, a²₂₀, a²₂₁, a²₂₂, a²₂₃, a²₂₄ and a²₂₅, from which four blocks of elements are formed, i.e., a first block (a²₁₆, a²₁₇, a²₂₁ and a²₂₂), a second block (a²₁₇, a²₁₈, a²₂₂ and a²₂₃), a third block (a²₁₈, a²₁₉, a²₂₃ and a²₂₄), and a fourth block (a²₁₉, a²₂₀, a²₂₄ and a²₂₅). Fourth quadrant a³_{q4} includes elements a³₁₆, a³₁₇, a³₁₈, a³₁₉, a³₂₀, a³₂₁, a³₂₂, a³₂₃, a³₂₄ and a³₂₅, from which four blocks of elements are formed, i.e., a first block (a³₁₆, a³₁₇, a³₂₁ and a³₂₂), a second block (a³₁₇, a³₁₈, a³₂₂ and a³₂₃), a third block (a³₁₈, a³₁₉, a³₂₃ and a³₂₄), and a fourth block (a³₁₉, a³₂₀, a³₂₄ and a³₂₅). Fourth quadrant a⁴_{q4} includes elements a⁴₁₆, a⁴₁₇, a⁴₁₈, a⁴₁₉, a⁴₂₀, a⁴₂₁, a⁴₂₂, a⁴₂₃, a⁴₂₄ and a⁴₂₅, from which four blocks of elements are formed, i.e., a first block (a⁴₁₆, a⁴₁₇, a⁴₂₁ and a⁴₂₂), a second block (a⁴₁₇, a⁴₁₈, a⁴₂₂ and a⁴₂₃), a third block (a⁴₁₈, a⁴₁₉, a⁴₂₃ and a⁴₂₄), and a fourth block (a⁴₁₉, a⁴₂₀, a⁴₂₄ and a⁴₂₅).

Output feature maps 206 may also be divided into four quadrants; in this case, each quadrant spans all four output data matrices 206¹, 206², 206³ and 206⁴. The first quadrant spans the top (first) row of each output data matrix, the second quadrant spans the second row of each output data matrix, the third quadrant spans the third row of each output data matrix, and the fourth quadrant spans the fourth (bottom) row of each output data matrix. The first quadrant for output feature maps 206 (o_{q1}), is depicted; the remaining three quadrants are not depicted for clarity.

First quadrant o_{q1} includes o¹₁, o¹₂, o¹₃, o¹₄, o²₁, o²₂, o²₃, o²₄, o³₁, o³₂, o³₃, o³₄, o⁴₁, o⁴₂, o⁴₃ and o⁴₄. Second quadrant o_{q2} includes o¹₅, o¹₆, o¹₇, o¹₈, o²₅, o²₆, o²₇, o²₈, o³₅, o³₆, o³₇, o³₈, o⁴₅, o⁴₆, o⁴₇ and o⁴₈. Third quadrant o_{q3} includes o¹₉, o¹₁₀, o¹₁₁, o¹₁₂, o²₉, o²₁₀, o²₁₁, o²₁₂, o³₉, o³₁₀, o³₁₁, o³₁₂, o⁴₉, o⁴₁₀, o⁴₁₁ and o⁴₁₂. Fourth quadrant o_{q4} includes o¹₁₃, o¹₁₄, o¹₁₅, o¹₁₆, o²₁₃, o²₁₄, o²₁₅, o²₁₆, o³₁₃, o³₁₄, o³₁₅, o³₁₆, o⁴₁₃, o⁴₁₄, o⁴₁₅ and o⁴₁₆.

Generally, each output element within output data matrices 206¹, 206², 206³ and 206⁴ is the sum of the dot products of one of the weight sets 202¹, 202², 202³ and 202⁴ and a block of activation elements within a particular quadrant of input data matrices 204¹, 204², 204³ and 204⁴.

The calculation of the output elements in quadrant o_{q1} follows.

Output element o¹₁ of output data matrix 206¹ is the sum of the dot products of weight set 202¹ and the first block of activation elements within first quadrants a¹_{q1}, a²_{q1}, a³_{q1} and a⁴_{q1} of input data matrices 204¹, 204², 204³ and 204⁴, respectively. The first block of activation elements within first quadrants a¹_{q1}, a²_{q1}, a³_{q1} and a⁴_{q1} includes a¹₁, a¹₂, a¹₆ and a¹₇; a²₁, a²₂, a²₆ and a²₇; a³₁, a³₂, a₃⁶ and a³₇; and a⁴ᵢ, a⁴₂, a⁴₆ and a⁴₇, respectively.

More particularly, the following dot products are summed to generate output element o¹₁: the dot product of the first weight matrix of weight set 202¹ and the first block of quadrant a¹_{q1} (i.e., w¹₁·a¹₁+w¹₂·a¹₂+w¹₃·a¹₆+w¹₄·a¹₇), the dot product of the second weight matrix of weight set 202¹ and the first block of quadrant a²_{q1} (i.e., w¹₅·a²₁+w¹₆·a²₂+w¹₇·a²₆+w¹₈·a²₇), the dot product of the third weight matrix of weight set 202¹ and the first block of quadrant a³_{q1} (i.e., w¹₉·a³₁+w¹₁₀·a³₂+w¹₁₁·a³₆+w¹₁₂·a³₇), and the dot product of the fourth weight matrix of weight set 202¹ and the first block of quadrant a⁴_{q1} (i.e., w¹₁₃·a⁴₁+w¹₁₄·a⁴₂+w¹₁₅·a⁴₆+w¹₁₆·a⁴₇).

Similarly, output element o²₁ of output data matrix 206² is the sum of the dot products of weight set 202² and the first block of activation elements within first quadrants a¹_{q1}, a²_{q1}, a³_{q1} and a⁴_{q1} of input data matrices 204¹, 204², 204³ and 204⁴, respectively. Output element o³₁ of output data matrix 206³ is the sum of the dot products of weight set 202³ and the first block of activation elements within first quadrants a¹_{q1}, a²_{q1}, a³_{q1} and a⁴_{q1} of input data matrices 204¹, 204², 204³ and 204⁴, respectively. And, output element o⁴₁ of output data matrix 206⁴ is the sum of the dot products of weight set 202⁴ and the first block of activation elements within first quadrants a¹_{q1}, a²_{q1}, a³_{q1} and a⁴_{q1} of input data matrices 204¹, 204², 204³ and 204⁴, respectively.

Output element o¹₂ of output data matrix 206¹ is the sum of the dot products of weight set 202¹ and the second block of activation elements within the first quadrants a¹_{q1}, a²_{q1}, a³_{q1} and a⁴_{q1} of input data matrices 204¹, 204², 204³ and 204⁴, respectively. The second block of activation elements within the first quadrants a¹_{q1}, a²_{q1}, a³_{q1} and a⁴_{q1} includes a¹₂, a¹₃, a¹₇ and a¹₈; a²₂, a²₃, a²₇ and a²₈; a³₂, a³₃, a³₇ and a³₈; and a⁴₂, a⁴₃, a⁴₇ and a⁴₈, respectively.

More particularly, the following dot products are summed to generate output element o¹₂: the dot product of the first weight matrix of weight set 202¹ and the second block of quadrant a¹_{q1} (i.e., w¹₁·a¹₂+w¹₂·a¹₃+w¹₃·a¹₇+w¹₄·a¹₈) , the dot product of the second weight matrix of weight set 202¹ and the second block of quadrant a²_{q1} (i.e., w¹₅·a²₂+w¹₆·a²₃+w¹₇·a²₇+w¹₈·a²₈) the dot product of the third weight matrix of weight set 202¹ and the second block of quadrant a³_{q1} (i.e., w¹₉·a³₂+w¹₁₀·a³₃+w¹₁₁·a³₇+w¹₁₂·a³₈), and the dot product of the fourth weight matrix of weight set 202¹ and the second block of quadrant a⁴_{q1} (i.e., w¹₁₃·a⁴₂+w¹₁₄·a⁴₃+w¹₁₅·a⁴₇+w¹₁₆·a⁴₈).

Similarly, output element o²₂ of output data matrix 206² is the sum of the dot products of weight set 202² and the second block of activation elements within first quadrants a¹_{q1}, a²_{q1}, a³_{q1} and a⁴_{q1} of input data matrices 204¹, 204², 204³ and 204⁴, respectively. Output element o³₂ of output data matrix 206³ is the sum of the dot products of weight set 202³ and the second block of activation elements within first quadrants a¹_{q1}, a²_{q1}, a³_{q1} and a⁴_{q1} of input data matrices 204¹, 204², 204³ and 204⁴, respectively. And, output element o⁴₂ of output data matrix 206⁴ is the sum of the dot products of weight set 202⁴ and the second block of activation elements within the quadrants a¹_{q1}, a²_{q1}, a³_{q1} and a⁴_{q1} of input data matrices 204¹, 204², 204³ and 204⁴, respectively.

And so on for output elements o¹₃ and o¹₄, o²₃ and o²₄, o³₃ and o³₄, and o⁴₃ and o⁴₄ of the first rows of output data matrices 206¹, 206², 206³ and 206⁴.

With respect to quadrant o_{q2}, output element o¹₅ of output data matrix 206¹ is the sum of the dot products of weight set 202¹ and the first block of activation elements within second quadrants a¹_{q2}, a²_{q2}, a³_{q2} and a⁴_{q2} of input data matrices 204¹, 204², 204³ and 204⁴, respectively. Output element o²₅ of output data matrix 206² is the sum of the dot products of weight set 202² and the first block of activation elements within second quadrants a¹_{q2}, a²_{q2}, a³_{q2} and a⁴_{q2} of input data matrices 204¹, 204², 204³ and 204⁴, respectively. Output element o³₅ of output data matrix 206³ is the sum of the dot products of weight set 202³ and the first block of activation elements within second quadrants a¹_{q2}, a²_{q2}, a³_{q2} and a⁴_{q2} of input data matrices 204¹, 204², 204³ and 204⁴, respectively. And, output element o⁴₅ of output data matrix 206⁴ is the sum of the dot products of weight set 202⁴ and the first block of activation elements within second quadrants a¹_{q2}, a²_{q2}, a³_{q2} and a⁴_{q2} of input data matrices 204¹, 204², 204³ and 204⁴, respectively. And so on for output elements o¹₆, o¹₇ and o¹₈, o²₆, o²₇ and o²₈, o³₆, o³₇ and o³₈, and o⁴₆, o⁴₇ and o⁴₈ of the second rows of output data matrices 206¹, 206², 206³ and 206⁴.

With respect to quadrant o_{q3}, output element o¹₉ of output data matrix 206¹ is the sum of the dot products of weight set 202¹ and the first block of activation elements within third quadrants a¹_{q3}, a²_{q3}, a³_{q3} and a⁴_{q3} of input data matrices 204¹, 204², 204³ and 204⁴, respectively. Output element o²₉ of output data matrix 206² is the sum of the dot products of weight set 202² and the first block of activation elements within third quadrants a¹_{q3}, a²_{q3}, a³_{q3} and a⁴_{q3} of input data matrices 204¹, 204², 204³ and 204⁴, respectively. Output element o³₉ of output data matrix 206³ is the sum of the dot products of weight set 202³ and the first block of activation elements within third quadrants a¹_{q3}, a²_{q3}, a³_{q3} and a⁴_{q3} of input data matrices 204¹, 204², 204³ and 204⁴, respectively. And, output element o⁴₉ of output data matrix 206⁴ is the sum of the dot products of weight set 202⁴ and the first block of activation elements within third quadrants a¹_{q3}, a²_{q3}, a³_{q3} and a⁴_{q3} of input data matrices 204¹, 204², 204³ and 204⁴, respectively. And so on for output elements o¹₁₀, o¹₁₁ and o¹₁₂, o²₁₀, o²₁₁ and o²₁₂, o³₁₀, o³₁₁ and o³₁₂, and o⁴₁₀, o⁴₁₁ and o⁴₁₂ of the third rows of output data matrices 206¹, 206², 206³ and 206⁴.

With respect to quadrant o_{q4}, output element o¹₁₃ of output data matrix 206¹ is the sum of the dot products of weight set 202¹ and the first block of activation elements within fourth quadrants a¹_{q4}, a²_{q4}, a³_{q4} and a⁴_{q4} of input data matrices 204¹, 204², 204³ and 204⁴, respectively. Output element o²₁₃ of output data matrix 206² is the sum of the dot products of weight set 202² and the first block of activation elements within fourth quadrants a¹_{q4}, a²_{q4}, a³_{q4} and a⁴_{q4} of input data matrices 204¹, 204², 204³ and 204⁴, respectively. Output element o³₁₃ of output data matrix 206³ is the sum of the dot products of weight set 202³ and the first block of activation elements within fourth quadrants a¹_{q4}, a²_{q4}, a³_{q4} and a⁴_{q4} of input data matrices 204¹, 204², 204³ and 204⁴, respectively. And, output element o⁴₁₃ of output data matrix 206⁴ is the sum of the dot products of weight set 202⁴ and the first block of activation elements within third quadrants a¹_{q4}, a²_{q4}, a³_{q4} and a⁴_{q4} of input data matrices 204¹, 204², 204³ and 204⁴, respectively. And so on for output elements o¹₁₄, o¹₁₅ and o¹₁₆, o²₁₄, o²₁₅ and o²₁₆, o³₁₄, o³₁₅ and o³₁₆, and o⁴₁₄, o⁴₁₅ and o⁴₁₆ of the fourth rows of output data matrices 206¹, 206², 206³ and 206⁴.

FIG. 3B depicts converted convolutional layer calculation 210 for a CNN, while FIG. 3C depicts converted input data matrix 214, in accordance with an embodiment of the present disclosure.

In one embodiment, the convolutional layer calculations for CNNs may be converted into GEMM operations for processing by one or more MMAs. Convolution layer calculation 200 is converted into a GEMM operation by converting filters 202 into converted weight matrix 212, converting input feature maps 204 into converted input data matrix 214, and then multiplying converted weight matrix 212 and converted input data matrix 214 to generate converted output data matrix 216. Because simple matrix multiplication is performed rather than a convolution operation, each output element within converted output data matrix 216 is the dot product of one row of converted weight matrix 212 and one column of converted input data matrix 214. Converted output data matrix 216 is then reformed into output feature maps 206.

Converted weight matrix 212 is a 4×16 matrix, and includes converted weight sets 212¹, 212², 212³ and 212⁴. Weight set 202¹ is flattened to form converted weight set 212¹, i.e., the first row, and includes weights w¹₁, w¹₂, w¹₃, w¹₄, w¹₅, w¹₆, w¹₇, w¹₈, w¹₉, w¹₁₀, w¹₁₁, w¹₁₂, w¹₁₃, w¹₁₄, w¹₁₅ and w¹₁₆. Weight set 202² is flattened to form converted weight set 212², i.e., the second row, and includes weights w²₁, w²₂, w²₃, w²₄, w²₅, w²₆, w²₇, w²₈, w²₉, w²₁₀, w²₁₁, w²₁₂, w²₁₃, w²₁₄, w²₁₅ and w²₁₆. Weight set 202³ is flattened to form converted weight set 212³, i.e., the third row, and includes weights w³₁, w³₂, w³₃, w³₄, w³₅, w³₆, w³₇, w³₈, w³₉, w³₁₀, w³₁₁, w³₁₂, w³₁₃, w³₁₄, w³₁₅ and w³₁₆. And, weight set 202⁴ is flattened to form converted weight set 212⁴, i.e., the fourth row, and includes weights w⁴₁, w⁴₂, w⁴₃, w⁴₄, w⁴₅, w⁴₆, w⁴₇, w⁴₅, w⁴₉, w⁴₁₀, w⁴₁₁, w⁴₁₂, w⁴₁₃, w⁴₁₄, w⁴₁₅and w⁴₁₆.

Converted input data matrix 214 is a 16×16 matrix, and includes the blocks of each quadrant of input data matrices 204¹, 204², 204³ and 204⁴, i.e., quadrants a¹_{q1}, a¹_{q2}, a¹_{q3}, a¹_{q4}, a²_{q1}, a²_{q2}, a²_{q3}, a²_{q4}, a³_{q1}, a³_{q2}, a³_{q3}, a³_{q4}, a⁴_{q1}, a⁴_{q2}, a⁴_{q3} and a⁴_{q4}, respectively. Generally, each block is flattened to form a portion of a single column of converted input data matrix 214.

More particularly, the first column of converted input matrix 214 includes the first blocks from quadrants a¹_{q1}, a²_{q1}, a³_{q1} and a⁴_{q1}, i.e., activations a¹₁, a¹₂, a¹₆, a¹₇, a²₂, a²₂, a²₆, a²₇, a³₁, a³₂, a³₆, a³₇, a⁴₁, a⁴₂, a⁴₆, and a⁴₇. The second column of converted input matrix 214 includes the second blocks from quadrants a¹_{q1}, a²_{q1}, a³_{q1} and a⁴_{q1}, i.e., activations a¹₂, a¹₃, a¹₇, a¹₈, a²₂, a²₃, a²₇, a²₈, a³₂, a³₃, a³₇, a³₈, a⁴₂, a⁴₃, a⁴₇, and a⁴₈. The third column of converted input matrix 214 includes the third blocks from quadrants a¹_{q1}, a²_{q1}, a³_{q1} and a⁴_{q1}, i.e., activations a¹₃, a¹₄, a¹₈, a¹₉, a²₃, a²₄, a²₈, a²₉, a³₃, a³₄, a³₈, a³₉, a⁴₃, a⁴₄, a⁴₈, and a⁴₉. And, the fourth column of converted input matrix 214 includes the fourth blocks from quadrants a¹_{q1}, a²_{q1}, a³_{q1} and a⁴_{q1}, i.e., activations a¹₄, a¹₅, a¹₉, a¹₁₀, a²₄, a²₅, a²₉, a²₁₀, a³₄, a³₅, a³₉, a³₁₀, a⁴₄, a⁴₅, a⁴₉, and a⁴₁₀.

The remaining columns of converted input data matrix 214 are formed in a similar manner. The fourth to the eighth columns are formed from the blocks of quadrants a¹_{q2}, a²_{q2}, a³_{q2} and a⁴_{q2}, the ninth to the twelfth columns are formed from the blocks of quadrants a¹_{q3}, a²_{q3}, a³_{q3} and a⁴_{q3}, and the thirteenth to the sixteenth columns are formed from the blocks of quadrants a¹_{q4}, a²_{q4}, a³_{q4} and a⁴_{q4}.

Converted output data matrix 216 is a 4×16 matrix, and includes flattened versions of output data matrices 206¹, 206², 206³ and 206⁴, i.e., converted output data matrices 216¹, 216², 216³ and 216⁴. Converted output data matrix 216 may also be arranged into four quadrants o_{q1}, o_{q2}, o_{q3} and o_{q4}, which include the same output elements as the four quadrants o_{q1}, o_{q2}, o_{q3} and o_{q4} of output feature maps 206.

The calculation of the output elements in the first row of quadrant o_{q1} of

converted output data matrix 216 follows.

Output element o¹₁ is the dot product of the first row of converted weight matrix 212, i.e., converted weight set 212¹, and the first column of converted input data matrix 214. More particularly, output element o¹₁ is equal to w¹₁·a₁+w¹₂·a¹₂+w¹₃·a¹₆+w¹₄·a¹₇+w¹₅·a²₁+w¹₆·a²₂+w¹₇·a²₆+w¹₈·a²₇+w¹₉·a³₁+w¹₁₀·a³₂+w¹₁₁·a³₆+w¹₁₂·a³₇+w¹₁₃·a⁴₁+w¹₁₄·a⁴₂+w¹₁₅·a⁴₆+w¹₁₆·a⁴. As shown above, output element o¹₁ of converted output data matrix 216 is equal to output element o¹₁ of output feature maps 206.

Output element o¹₂ is the dot product of the first row of converted weight matrix 212, i.e., converted weight set 212¹, and the second column of converted input data matrix 214. More particularly, output element o¹₂ is equal to w¹₁·a¹₂+w¹₂·a¹₃+w¹₃·a¹₇+w¹₄·a¹₈+w¹₅·a²₂+w¹₆·a²₃+w¹₇·a²₇+w¹₈·a²₈+w¹₉·a³₂+w¹₁₀·a³₃+w¹₁₁·a³₇+w¹₁₂·a³₈+w¹₁₃·a⁴₂+w¹₁₄·a⁴₃+w¹₁₅·a⁴₇+w¹₁₆·a⁴₈. As shown above, output element o¹₂ of converted output data matrix 216 is equal to output element o¹₂ of output feature maps 206.

Output element o¹₃ is the dot product of the first row of converted weight matrix 212, i.e., converted weight set 212¹, and the third column of converted input data matrix 214. More particularly, output element o¹₃ is equal to w¹₁·a¹₃+w¹₂·a₄+w¹₃·a¹₈+w¹₄·a¹₉+w¹₅·a²₃+w¹₆·a²₄+w¹₇·a²₈+w¹₈·a²₉+w¹₉·a³₃+w¹₁₀·a³₄+w¹₁₁·a³₈+w¹₁₂·a³₉+w¹₁₃·a⁴₃+w¹₁₄·a⁴₄+w¹₁₅·a⁴₈+w¹₁₆·a⁴₉. As shown above, output element o¹₃ of converted output data matrix 216 is equal to output element o¹₃ of output feature maps 206.

Output element o¹₄ is the dot product of the first row of converted weight matrix 212, i.e., converted weight set 212¹, and the fourth column of converted input data matrix 214. More particularly, output element o¹₄ is equal to w¹₁·a¹₄+w¹₂·a¹₅+w¹₃·a¹₉+w¹₄·a¹₁₀+w¹₅·a²₄w¹₆·a²₅+w¹₇·a²₉+w¹₈·a²₁₀+w¹₉·a³₄+w¹₁₀·a³₅+w¹₁₁·a³₉+w¹₁₂·a³₁₀+w¹₁₃·a⁴₄+w¹₁₄·a⁴₅+w¹₁₅·a⁴₉+w¹₁₆·a⁴₁₀. As shown above, output element o¹₄ of converted output data matrix 216 is equal to output element o¹₄ of output feature maps 206.

For the second row of quadrant o_{q1}, output element o²₁ is the dot product of the second row of converted weight matrix 212, i.e., converted weight set 212², and the first column of converted input data matrix 214, output element o²₂ is the dot product of the second row of converted weight matrix 212, i.e., converted weight set 212², and the second column of converted input data matrix 214, output element o²₃ is the dot product of the second row of converted weight matrix 212, i.e., converted weight set 212², and the third column of converted input data matrix 214, and output element o²₄ is the dot product of the second row of converted weight matrix 212, i.e., converted weight set 212², and the fourth column of converted input data matrix 214.

For the third row of quadrant o_{q1}, output element o³₁ is the dot product of the third row of converted weight matrix 212, i.e., converted weight set 212³, and the first column of converted input data matrix 214, output element o³₂ is the dot product of the third row of converted weight matrix 212, i.e., converted weight set 212³, and the second column of converted input data matrix 214, output element o³₃ is the dot product of the third row of converted weight matrix 212, i.e., converted weight set 212³, and the third column of converted input data matrix 214, and output element o³₄ is the dot product of the third row of converted weight matrix 212, i.e., converted weight set 212³, and the fourth column of converted input data matrix 214.

For the fourth row of quadrant o^{q1}, output element o⁴₁ is the dot product of the fourth row of converted weight matrix 212, i.e., converted weight set 212⁴, and the first column of converted input data matrix 214, output element o⁴₂ is the dot product of the fourth row of converted weight matrix 212, i.e., converted weight set 212⁴, and the second column of converted input data matrix 214, output element o⁴₃ is the dot product of the fourth row of converted weight matrix 212, i.e., converted weight set 212⁴, and the third column of converted input data matrix 214, and output element o⁴₄ is the dot product of the fourth row of converted weight matrix 212, i.e., converted weight set 212⁴, and the fourth column of converted input data matrix 214.

The elements of the quadrants o_{q2}, o_{q3} and o_{q4} are calculated in a similar manner.

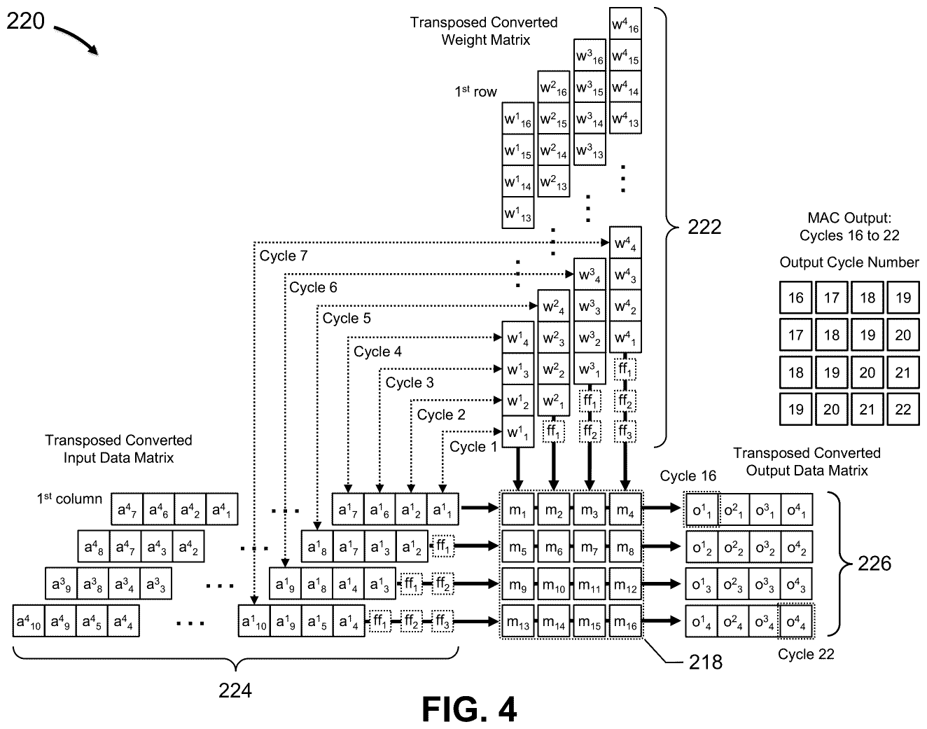

FIG. 4 depicts data flow diagram 220 for MAC array 218.

As noted above, GEMM operations may be implemented in one or more MMAs, which are dedicated ANN hardware accelerators that include one or more arrays of MAC units. In this embodiment, MAC array 218 is a systolic, output stationary array that implements converted convolution operation 210 using a 4×4 array of MAC units m₁, m₂, m₃, m₄, m₅, m₆, m₇, m₈, m₉, m₁₀, m₁₁, m₁₂, m₁₃, m₁₄, m₁₅ and m₁₆. The orientation of transposed converted weight matrix 222, transposed converted input data matrix 224, and transposed converted output data matrix 226 relative to MAC array 218 simplifies illustration; other orientations are also contemplated.

Each MAC unit calculates a dot product, between a row of converted weight matrix 212 and a column of converted input data matrix 214, to generate an element of converted output data matrix 216. Generally, a MAC unit includes, inter alia, a multiplier, an adder and a storage register. Each MAC unit is reset by clearing or zeroing its storage register prior to, or at the start of, a new dot product calculation.

Generally, the rows from converted weight matrix 212 are read from local memory, enter MAC array 218 at the first row of MAC units m₁, m₂, m₃ and m₄, and propagate one MAC unit down at the beginning of each processing cycle. Similarly, the columns from converted input data matrix 214 are read from local memory, enter MAC array 218 at the first column of MAC units m₁, m₅, m₉ and m₁₃, and propagate one MAC unit to the right at the beginning of each processing cycle.

The dot product calculations performed by MAC unit m₁ for the blocks of the first quadrants a¹_{q1}, a²_{q1}, a³_{q1} and a⁴_{q1} of converted input data matrix 214 are discussed in detail below, while the dot product calculations performed by the remaining MAC units of MAC array 218 are summarized below.

MAC unit m₁ calculates the dot product of the first row of converted weight matrix 212 (i.e., converted weight set 212¹) and the first column of converted input data matrix 214 to generate element o¹₁ of converted output data matrix 216. During the processing cycle 1, MAC unit m₁ receives a₁ and w¹₁ from local memory, multiplies a₁ and w¹₁ to generate an intermediate product, adds the intermediate product to the value stored in the storage register (i.e., 0), and stores the accumulated result back in the storage register. During processing cycle 2, MAC unit m₁ transmits a₁ to MAC unit m₂ and w¹₁ to MAC unit m₅, receives a₂ and w¹₂ from local memory, multiplies a₂ and w¹₂ to generate an intermediate product, adds the intermediate product to the value stored in the storage register, and stores the accumulated result back in the storage register.

During processing cycle 3, MAC unit m₁ transmits a₂ to MAC unit m₂ and w¹₂ to MAC unit m₅, receives as and w¹₃ from local memory, multiplies a₆ and w¹₃ to generate an intermediate product, adds the intermediate product to the value stored in the storage register, and stores the accumulated result back in the storage register. During processing cycle 4, MAC unit m₁ transmits as to MAC unit m₂ and w¹₃ to MAC unit m₅, receives a₇ and w¹₄ from the local memory, multiplies a₇ and w¹₄ to generate an intermediate product, adds the intermediate product to the value stored in the storage register, and stores the accumulated result back in the storage register.

Processing cycles 5 through 16 multiply and accumulate the remaining 12 elements of the first row of converted weight matrix 212 and the first column of converted input data matrix 214. At the end of the processing cycle 16, MAC unit m₁ outputs element o¹₁.

The remainder of the first row of MAC array 218 includes MAC units m₂, m₃ and m₄.

After an initial delay of one processing cycle, MAC unit m₂ receives weights from the first delay register ff₁ and input data from MAC unit m₁, transmits weights to MAC unit m₆ and input data to MAC unit m₃, and calculates the dot product of the second row of converted weight matrix 212 (i.e., converted weight set 212²) and the first column of converted input data matrix 214 to generate element o²₁ of converted output data matrix 216. The initial delay of one processing cycle allows the delay pipeline (i.e., delay register ff₁) to be filled with weights transferred from memory, and the input data to become available from MAC unit m₁. At the end of the processing cycle 17, MAC unit m₂ outputs element o²₁.

After an initial delay of two processing cycles, MAC unit m₃ receives weights from the second delay register ff₂ and input data from MAC unit m₂, transmits weights to MAC unit m₇ and input data to MAC unit m₄, and calculates the dot product of the third row of converted weight matrix 212 (i.e., converted weight set 212³) and the first column of converted input data matrix 214 to generate element o³₁ of converted output data matrix 216. The initial delay of two processing cycles allows the delay pipeline (i.e., delay registers ff₁ and ff₂) to be filled with weights transferred from memory, and the input data to become available from MAC unit m₂. At the end of processing cycle 18, MAC unit m₃ outputs element o³₁.

After an initial delay of three processing cycles, MAC unit m₄ receives weights from the third delay register ff₃ and input data from MAC unit m₃, transmits weights to MAC unit m₈, and calculates the dot product of the fourth row of converted weight matrix 212 (i.e., converted weight set 212⁴) and the first column of converted input data matrix 214 to generate element o⁴₁ of converted output data matrix 216. The initial delay of three processing cycles allows the delay pipeline (i.e., delay registers ff₁, ff₂ and ff₃) to be filled with weights transferred from memory, and the input data to become available from MAC unit m₃. At the end of processing cycle 19, MAC unit m₄ outputs element o⁴₁.

The second row of MAC array 218 includes MAC units m₅, m₆, m₇ and m₈.

After an initial delay of one processing cycle, MAC unit m₅ receives weights from MAC unit m₁ and input data from a first delay register ff₁, transmits weights to MAC unit m₉ and input data to MAC unit m₆, and calculates the dot product of the first row of converted weight matrix 212 (i.e., converted weight set 212¹) and the second column of converted input data matrix 214 to generate element o¹₂ of converted output data matrix 216. The initial delay of one processing cycle allows the delay pipeline (i.e., delay register ff₁) to be filled with input data transferred from memory, and the weights to become available from MAC unit m₁. At the end of processing cycle 17, MAC unit m₅ outputs element o¹₂.

After an initial delay of two processing cycles, MAC unit m₆ receives weights from MAC unit m₂ and input data from MAC unit m₅, transmits weights to MAC unit m₁₀ and input data to MAC unit m₇, and calculates the dot product of the second row of converted weight matrix 212 (i.e., converted weight set 212²) and the second column of converted input data matrix 214 to generate element o²₂ of converted output data matrix 216. The initial delay of two processing cycles allows the weights to become available from MAC unit m₂, and the input data to become available from MAC unit m₅. At the end of processing cycle 18, MAC unit m₆ outputs element o²₂.

After an initial delay of three processing cycles, MAC unit m₇ receives weights from MAC unit m₃ and input data from MAC unit m₆, transmits weights to MAC unit m₁₁ and input data to MAC unit m₈, and calculates the dot product of the third row of converted weight matrix 212 (i.e., converted weight set 212³) and the second column of converted input data matrix 214 to generate element o³₂ of converted output data matrix 216. The initial delay of three processing cycles allows the weights to become available from MAC unit m₃, and the input data to become available from MAC unit m₆. At the end of processing cycle 19, MAC unit m₇ outputs element o³₂.

After an initial delay of four processing cycles, MAC unit m₈ receives weights from MAC unit m₄ and input data from MAC unit m₇, transmits weights to MAC unit m₁₂, and calculates the dot product of the fourth row of converted weight matrix 212 (i.e., converted weight set 212⁴) and the second column of converted input data matrix 214 to generate element o⁴₂ of converted output data matrix 216. The initial delay of four processing cycles allows the weights to become available from MAC unit m₄, and the input data to become available from MAC unit m₇. At the end of processing cycle 20, MAC unit m₈ outputs element o⁴₂.

The third row of MAC array 218 includes MAC units m₉, m₁₀, m₁₁ and m₁₂.

After an initial delay of two processing cycles, MAC unit m₉ receives weights from MAC unit m₅ and input data from a second delay register ff₂, transmits weights to MAC unit m₁₃ and input data to MAC unit m₁₀, and calculates the dot product of the first row of converted weight matrix 212 (i.e., converted weight set 212¹) and the third column of converted input data matrix 214 to generate element o¹₃ of converted output data matrix 216. The initial delay of two processing cycles allows the delay pipeline (i.e., delay registers ff₁ and ff₂) to be filled with input data transferred from memory, and the weights to become available from MAC unit m₅. At the end of processing cycle 18, MAC unit m₉ outputs element o¹₃.

After an initial delay of three processing cycles, MAC unit m₁₀ receives weights from MAC unit m₆ and input data from MAC unit m₉, transmits weights to MAC unit m₁₄ and input data to MAC unit m₁₁, and calculates the dot product of the second row of converted weight matrix 212 (i.e., converted weight set 212²) and the third column of converted input data matrix 214 to generate element o²₃ of converted output data matrix 216. The initial delay of three processing cycles allows the weights to become available from MAC unit m₆, and the input data to become available from MAC unit m₉. At the end of processing cycle 19, MAC unit m₁₀ outputs element o²₃.

After an initial delay of four processing cycles, MAC unit mil receives weights from MAC unit m₇ and input data from MAC unit m₁₀, transmits weights to MAC unit m₁₅ and input data to MAC unit m₁₂, and calculates the dot product of the third row of converted weight matrix 212 (i.e., converted weight set 212³) and the third column of converted input data matrix 214 to generate element o³₃ of converted output data matrix 216. The initial delay of four processing cycles allows the weights to become available from MAC unit m₇, and the input data to become available from MAC unit m₁₀. At the end of processing cycle 20, MAC unit m₁₁ outputs element o³₃.

After an initial delay of five processing cycles, MAC unit m₁₂ receives weights from MAC unit m₈ and input data from MAC unit m₁₁, transmits weights to MAC unit m₁₆, and calculates the dot product of the fourth row of converted weight matrix 212 (i.e., converted weight set 212⁴) and the third column of converted input data matrix 214 to generate element o⁴₃ of converted output data matrix 216. The initial delay of five processing cycles allows the weights to become available from MAC unit m₈, and the input data to become available from MAC unit m₁₁. At the end of processing cycle 21, MAC unit m₁₂ outputs element o⁴₃.

The fourth row of MAC array 218 includes MAC units m₁₃, m₁₄, m₁₅ and m₁₆.

After an initial delay of three processing cycles, MAC unit m₁₃ receives weights from MAC unit m₉ and input data from a third delay register ff₃, transmits input data to MAC unit m₁₄, and calculates the dot product of the first row of converted weight matrix 212 (i.e., converted weight set 212¹) and the fourth column of converted input data matrix 214 to generate element o¹₄ of converted output data matrix 216. The initial delay of three processing cycles allows the delay pipeline (i.e., delay registers ff₁, ff₂ and ff₃) to be filled with input data transferred from memory, and the weights to become available from MAC unit m₉. At the end of processing cycle 19, MAC unit m₁₃ outputs element o¹₄.

After an initial delay of four processing cycles, MAC unit m₁₄ receives weights from MAC unit m₁₀ and input data from MAC unit m₁₃, transmits input data to MAC unit m₁₅, and calculates the dot product of the second row of converted weight matrix 212 (i.e., converted weight set 212²) and the fourth column of converted input data matrix 214 to generate element o²₄ of converted output data matrix 216. The initial delay of four processing cycles allows the weights to become available from MAC unit m₁₀, and the input data to become available from MAC unit m₁₃. At the end of processing cycle 20, MAC unit m₁₄ outputs element o²₄.

After an initial delay of five processing cycles, MAC unit m₁₅ receives weights from MAC unit m₁₁ and input data from MAC unit m₁₄, transmits input data to MAC unit m₁₆, and calculates the dot product of the third row of converted weight matrix 212 (i.e., converted weight set 212³) and the fourth column of converted input data matrix 214 to generate element o³₄ of converted output data matrix 216. The initial delay of five processing cycles allows the weights to become available from MAC unit m₁₁, and the input data to become available from MAC unit m₁₄. At the end of processing cycle 21, MAC unit m₁₅ outputs element o³₄.

After an initial delay of six processing cycles, MAC unit m₁₆ receives weights from MAC unit m₁₂ and input data from MAC unit m₁₅, and calculates the dot product of the fourth row of converted weight matrix 212 (i.e., converted weight set 212⁴) and the fourth column of converted input data matrix 214 to generate element o⁴₄ of converted output data matrix 216. The initial delay of six processing cycles allows the weights to become available from MAC unit m₁₂, and the input data to become available from MAC unit m₁₅. At the end of processing cycle 22, MAC unit m₁₆ outputs element o⁴₄.

After the blocks of the first quadrants a¹_{q1}, a²_{q1}, a³_{q1} and a⁴_{q1} of converted input data matrix 214 have been processed, the next sequence of operations processes the blocks of the second quadrants a¹_{q2}, a²_{q2}, a³_{q2} and a⁴_{q2}. After the blocks of the second quadrants a¹_{q2}, a²_{q2}, a³_{q2} and a⁴_{q2} have been processed, the next sequence of operations processes the blocks of the third quadrants a¹_{q3}, a²_{q3}, a³_{q3} and a⁴_{q3}. And, after the blocks of the third quadrants a¹_{q3}, a²_{q3}, a³_{q3} and a⁴_{q3} have been processed, the final sequence of operations processes the blocks of the fourth quadrants a¹_{q4}, a²_{q4}, a³_{q4} and a⁴_{q4}. Converted weight matrix 212 is accessed for each sequence of operations.

As noted above, many machine learning inference applications employ quantized ANNs, such as quantized CNNs, that require high-throughput, low-precision matrix multiplication operations. A conventional ANN has fixed bit-width dot product datapaths, such as, for example, 8 bits, 16 bits, 32 bits, etc. MMAs that support conventional ANNs may be used to support quantized ANNs, and include one or more MAC unit arrays that multiply operands having corresponding fixed bit-widths, such as, for example, 8 bits, 16 bits, 32 bits, etc.

A sparse, quantized neural network promotes zero values for weight and/or activation elements during neural network training. For example, the weights, {wᵢ} and activations {aᵢ} are quantized into 8-bits:

w₁, aᵢ ϵ[−128, 127] (Eq. 1)

and then the pruning process generates as many possible zero values in {wᵢ} and {aᵢ}. The activations are dynamically quantized and pruned during inference.

According to the conventional scheme, sparsity is determined at the element (i.e., word) level for a quantized neural network model, i.e., an element has either a zero value or a non-zero value. Embodiments of the present disclosure, however, determine sparsity at the bit level for each element for a quantized neural network model, i.e., an element has a number of bits that are set to zero and a number of bits that are set to one. Generally, elements may have signed or unsigned values. A signed value includes a signed portion (e.g., sign bit) and a magnitude portion (e.g., magnitude bits), and the bit-level sparsity is determined based on the magnitude portion of the signed value. For example, if two 8-bit weights w₀ and w₁ have the following values:

w₀=20=0×14=b0001 0100

w₁=39=0×27=b0010 0111

then weights w₀ and w₁ contain 6 nonzero bits, and their bit sparsity is (2*8−6)/(2*8)=62.5%. A similar approach can be applied to calculate activation data sparsity as well.

Embodiments of the present disclosure quantize and prune a neural network to maximize bit sparsity. As noted above, one benefit of this optimization is to reduce the power consumption through minimizing signal toggling in the data path during inference. In one embodiment, the neural network is quantized and pruned during training toward a minimal Hamming Norm, which is a metric that measures how many bits are set (i.e., how many bits have a value of “1”) in the binary form of the weights and activations. Other metrics are also supported.

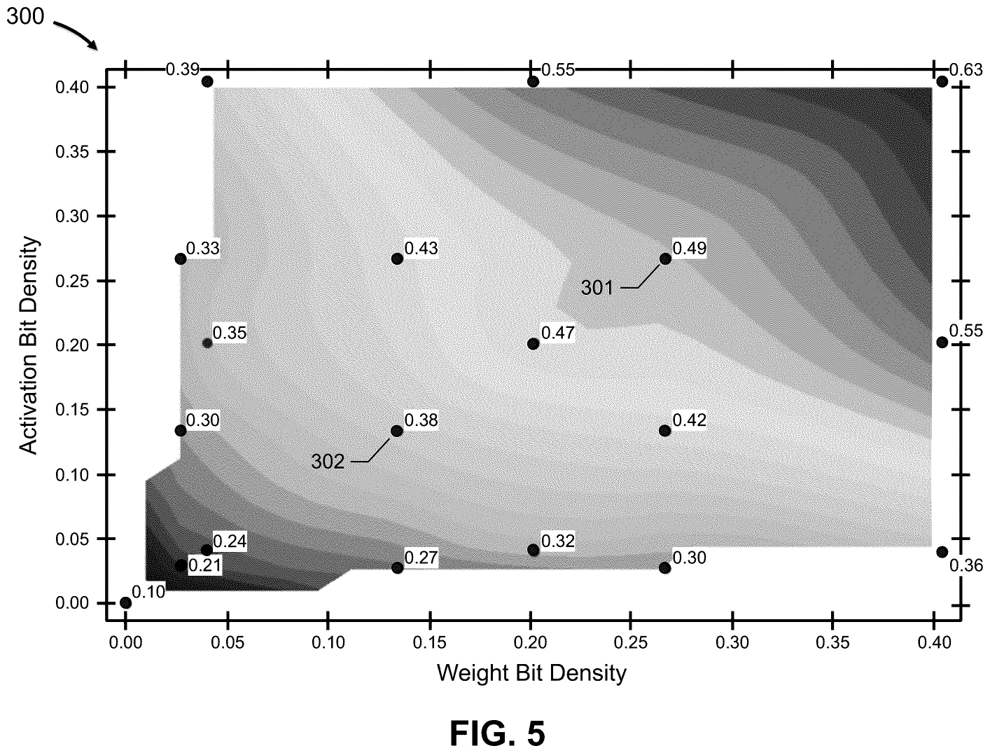

FIG. 5 depicts power consumption contour graph 300, in accordance with an embodiment of the present disclosure.

Power consumption contour graph 300 presents results from an activity-annotated extracted netlist simulation for an NPU that does not include optimizations for bit sparsity. The x-axis represents weight bit density (normalized to 1), the y-axis represents activation bit density (normalized to 1), and the NPU power consumption data values (normalized to 1) are displayed in a color-coded contour map.

For example, data point 301 has a weight bit density of 0.27, an activation bit density of 0.27 and an NPU power consumption value of 0.49, while data point 302 has a weight bit density of 0.14, an activation bit density of 0.14 and an NPU power consumption value of 0.38. The results clearly show that power consumption is significantly reduced as the weight and activation bit densities decrease, such as, for example, from typical values of 27% (e.g., data point 301) to 14% (e.g., data point 302). In this example, the power consumption is reduced by 22% (i.e., 1−0.38/0.49=0.22), which demonstrates the impact of increasing bit sparsity even with an NPU that does not include optimizations for bit sparsity.

Embodiments of the present disclosure reduce bit densities by gradually promoting zero-bits during neural network quantization aware training (QAT). In many embodiments, the weight bit density may be reduced during neural network QAT based on one or more pruning embodiments described below.

In certain embodiments, for each weight, each group of “N” consecutive bits that are set to one (“1”) are replaced by three zeros (“0”) and a single bit that is set to one at the next higher bit position. In one embodiment, N is greater than or equal to 3; other embodiments are also supported, such as N is greater than or equal to 2, N is greater than or equal to 4, etc. For example, if two 8-bit weights w₂ and w₃ have the following values:

w₂=116=0×74=b0111 0100

w₃=29=0×1D=b0001 1101

then weights w₂ and w₃ contain 8 nonzero bits, and their bit sparsity is (2*8−8)/(2*8)=50%. The pruned values are:

w₂^{p}=132=0×84=b1000 0100

w₃^{p}=33=0×21=b0010 0001

then weights w₂^{p} and w₃^{p} contain 4 nonzero bits, and their bit sparsity is (2*8−4)/(2*8)=75%.

In certain embodiments, for each weight, the maximum number of bits set to one (“1”) is reduced to N. In one embodiment, N is equal to 2; other embodiments are also supported, such as N is equal to 1, N is equal to 3, etc. For example, if two 8-bit weights w₂ and w₃ have the following values:

w₂=116=0×74=b0111 0100

w₃=29=0×1D=b0001 1101

then weights w₂ and w₃ contain 8 nonzero bits, and their bit sparsity is (2*8−8)/(2*8)=50%. The pruned values are:

w₂^{p}=96=0×60=b0110 0000

w₃^{p}=24=0×18=b0001 1000

then weights w₂^{p} and w₃^{p} contain 4 nonzero bits, and their bit sparsity is (2*8−4)/(2*8)=75%.

When N is equal to 1, the first set bit (i.e., the first and most significant bit set to “1”) is simply determined. The pruned values for weights w₂ and w₃ are:

w₂^{p}=64=0×40=b0100 0000

w₃^{p}=16=0×10=b0001 0000

and weights w₂^{p} and w₃^{p} contain 2 nonzero bits, and their bit sparsity is (2*8−2)/(2*8)=87.5%.

In certain embodiments, the average number of bits set to one (“1”) in all the weights is N and is developed by gradually pruning the bits set to one (“1”) that are close to the least significant bit (LSB) in each weight during training. For example, certain weights may have N+1 bits set to one (“1”), other weights may have N−1 bits set to one (“1”), etc. In one embodiment, N is equal to 2; other embodiments are also supported, such as N is equal to 1, N is equal to 3, etc.

Combinations of these embodiments are also supported, such as, for example, replacing consecutive set bits combined with reducing the number of set bits, etc.

In further embodiments of the present disclosure, weight and activation bit densities may be reduced during neural network QAT based on these pruning embodiments, and the activation bit density may be reduced during inference based on these pruning embodiments. In many embodiments, BPUs dynamically prune activation data during inference; in other embodiments, activation data may be pruned by a local processor, etc.

For example, an MMA with one or more MAC arrays may include BPUs within each MAC array to prune activation data. In one embodiment, MAC array 218 may include a BPU to process the data from each column of converted input data matrix 214 before the activation data enters MAC array 218 at the first column of MAC units mi, m5, mg and mis. In other examples, an MMA may include BPUs within a neural network directly implemented or hard-wired into silicon; similarly, an MMA may include BPUs within a neural network directly implemented by one or more FPGAs. Further examples include an NPU with one or more processing engines (PEs) may include BPUs within each PE to prune activation data, a GPU that is configured to execute an ANN may include BPUs, as needed, within each core or processing unit, etc.

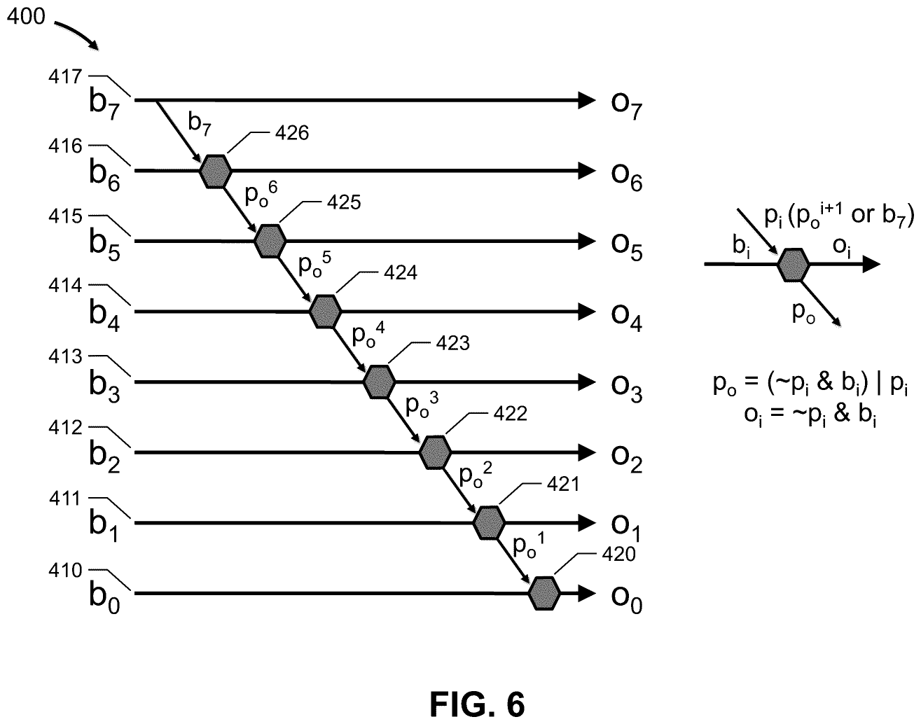

FIG. 6 depicts BPU 400, in accordance with an embodiment of the present disclosure.

Generally, BPU 400 receives an input data value, determines the first (most significant) set bit therein, and outputs a mask value that preserves the first set bit (“1”) and sets the subsequent (less significant) set bits to zero (“0”). BPU 400 includes, inter alia, bitlines 410, 411, 412, 413, 414, 415, 416 and 417, and processing nodes 420, 421, 422, 423, 424, 425 and 426.

In this embodiment, BPU 400 receives an 8-bit input data value over eight bitlines, and outputs an 8-bit mask value over eight bitlines. Bits b₀, b₁, b₂, b₃, b₄, b₅, b₆, and b₇ of the input data value are input over bitlines 410, 411, 412, 413, 414, 415, 416 and 417, respectively, and bits o₀, o₁, o₂, o₃, o₄, o₅, o₆ and o₇ of the mask value are output over bitlines 410, 411, 412, 413, 414, 415, 416 and 417, respectively. Bits b₀ and o₀ are the LSBs, while bits b₇ and o₇ are the MSBs.

Processing node 426 is coupled to bitline 416, bitline 417 and processing node 425. Processing node 425 is coupled to bitline 415, processing node 426 and processing node 424. Processing node 424 is coupled to bitline 414, processing node 425 and processing node 423. Processing node 423 is coupled to bitline 413, processing node 424 and processing node 422. Processing node 422 is coupled to bitline 412, processing node 423 and processing node 421. Processing node 421 is coupled to bitline 411, processing node 422 and processing node 420. Processing node 420 is coupled to bitline 410 and processing node 421.

In order to generate a mask of the first set bit, processing begins with bit b₇ (bitline 417) and flows down to each subsequent bitline.

For bitline 417, bit b₇ is simply output as bit o₇. When bit b₇ is set to one (“1”), o₇ is set to one (“1”) and the remaining bits o₆, o₅, o₄, o₃, o₂, o₁ and o₀ are set to zero (“0”) by processing nodes 420, 421, 422, 423, 424, 425 and 426. When bit b₇ is set to zero (“0”), o₇ is set to zero (“0”) and the remaining bits b₆, b₅, b₄, b₃, b₂, b₁ and b₀ are processed by processing nodes 420, 421, 422, 423, 424, 425 and 426 to determine the first set bit.

Generally, each processing node receives an input bit bi and an input signal pᵢ, and determines and outputs signal pₒ and bit oᵢ, as depicted in FIG. 6. The input signal pᵢ is received from a previous node (pₒⁱ⁺¹) or bitline (b⁷). Signal pₒ is determined by Equation 2:

pₒ=(˜pᵢ& bᵢ)|pᵢ (Eq. 2)

and the bit oᵢ is determined by Equation 3:

oᵢ=˜pᵢ& bᵢ (Eq. 3)

where the “˜” operator is the bitwise complement, the “&” operator is the bitwise AND, and the “|” is the bitwise OR.

For bitline 416, processing node 426 receives bit b₆ from bitline 416 and bit b₇ from bitline 417, generates signal pₒ⁶ using Equation 2 and bit o₆ using Equation 3, outputs bit o₆ along bitline 416, and outputs signal pₒ⁶ to processing node 425.

For bitline 415, processing node 425 receives bit b₅ from bitline 415 and signal pₒ⁶ from processing node 426, generates signal pₒ⁵ using Equation 2 and bit o₅ using Equation 3, outputs bit o⁵ along bitline 415, and outputs signal pₒ⁵ to processing node 424.

For bitline 414, processing node 424 receives bit b₄ from bitline 414 and signal pₒ⁵ from processing node 425, generates signal pₒ⁴ using Equation 2 and bit o⁴ using Equation 3, outputs bit o⁴ along bitline 414, and outputs signal pₒ⁴ to processing node 423.

For bitline 413, processing node 423 receives bit b₃ from bitline 413 and signal pₒ⁴ from processing node 424, generates signal pₒ³ using Equation 2 and bit o₃ using Equation 3, outputs bit o₃ along bitline 413, and outputs signal pₒ³ to processing node 4220.

For bitline 412, processing node 422 receives bit b₂ from bitline 412 and signal pₒ³ from processing node 423, generates signal pₒ² using Equation 2 and bit o₂ using Equation 3, outputs bit o₂ along bitline 412, and outputs signal pₒ² to processing node 421.

For bitline 411, processing node 421 receives bit b₁ from bitline 411 and signal pₒ² from processing node 422, generates signal pₒ¹ using Equation 2 and bit o₁ using Equation 3, outputs bit o₁ along bitline 411, and outputs signal pₒ¹ to processing node 420.

For bitline 410, processing node 420 receives bit b₀ from bitline 410 and signal pₒ¹ from processing node 421, generates bit oO₁ using Equation 3, and outputs bit o₀ along bitline 410.

While BPU 400 processes an 8-bit data value, such as an 8-bit activation value, other size data values are also supported by simply adding or removing bitlines and nodes.

In other embodiments, the most significant N set bits may be determined by cascading BPUs 400 spatially, or by performing N iterations sequentially using a single BPU 400. For example, to determine the second set bit of the top N set bits, the mask value output by the first BPU 400 is converted to its complement value and then combined with the input data value, using a bitwise AND, to generate an intermediate data value in which the first set bit has been changed to zero (“0”) and the subsequent bits have been preserved, i.e., either ones (“1's) or zeros (”0's).

In certain embodiments, the intermediate data value is input to a second BPU 400, and the mask value output by the second BPU 400 identifies the second set bit (i.e., the second set bit is set to one and the remaining bits are set to zero). The mask value output by the second BPU 400 is then combined with the mask value output by the first BPU 400, using a bitwise OR, to generate a final mask value that identifies the two most significant set bits (i.e., the first two set bits are set to one and the remaining bits are set to zero). And so on, if desired, for each additional set bit. In this manner, the most significant N set bits may be identified and retained during pruning, where N is 2, 3, 4, etc.

In other embodiments, the intermediate data value is input back to the first BPU 400 for a second iteration, and the mask value output by the first BPU 400 identifies the second set bit (i.e., the second set bit is set to one and the remaining bits are set to zero). The mask value output by the first BPU 400 after the second iteration is then combined with the mask value output by the first BPU 400 after the first iteration, using a bitwise OR, to generate a final mask value that identifies the two most significant set bits (i.e., the first two set bits are set to one and the remaining bits are set to zero). And so on, if desired, for each additional set bit. In this manner, the most significant N set bits may be identified and retained during pruning, where N is 2, 3, 4, etc.

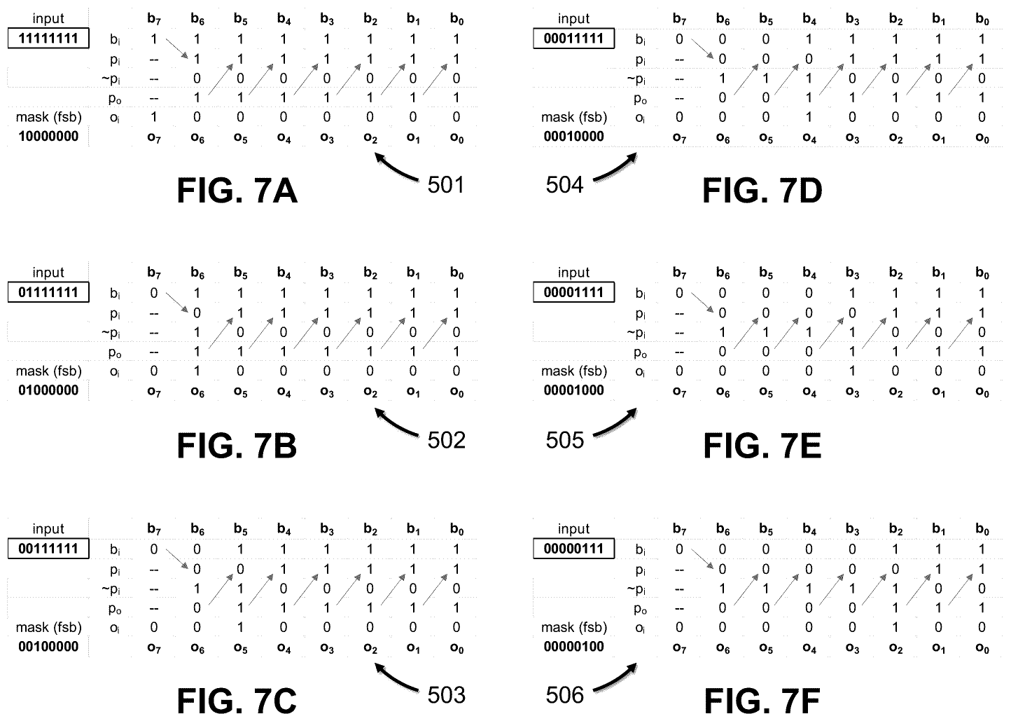

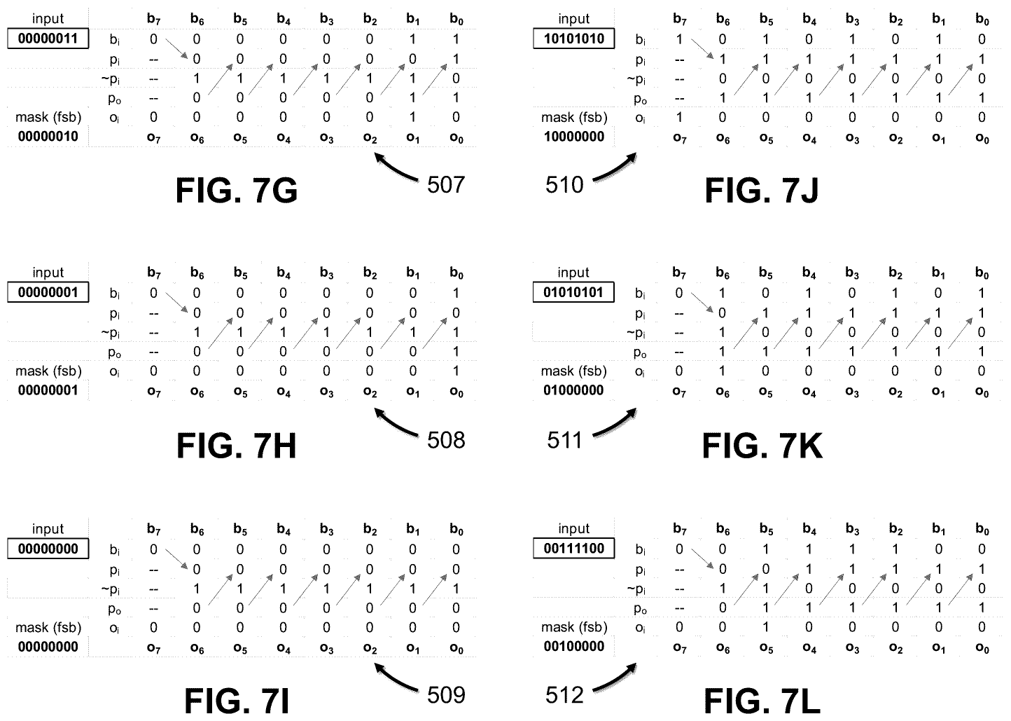

FIGS. 7A to 7L depict the generation of the mask of the first set bit for different input data values, in accordance with an embodiment of the present disclosure.

FIG. 7A depicts the calculation of the mask (first set bit or fsb) value, i.e., b1000 0000, from the input data value, i.e., b1111 1111, using Equations 2 and 3. The values of bᵢ, pᵢ, ˜pᵢ, pₒ and oᵢ are depicted for each bit bᵢ, and the input value for pᵢ is indicated by an arrow for bits b₆, b₅, b₄, b₃, b₂, b₁ and b₀.

FIG. 7B depicts the calculation of the mask (fsb) value, i.e., b0100 0000, from the input data value, i.e., b0111 1111, using Equations 2 and 3. FIG. 7C depicts the calculation of the mask (fsb) value, i.e., b0010 0000, from the input data value, i.e., b0011 1111, using Equations 2 and 3. FIG. 7D depicts the calculation of the mask (fsb) value, i.e., b0001 0000, from the input data value, i.e., b0001 1111, using Equations 2 and 3. FIG. 7E depicts the calculation of the mask (fsb) value, i.e., b0000 1000, from the input data value, i.e., b0000 1111, using Equations 2 and 3. FIG. 7F depicts the calculation of the mask (fsb) value, i.e., b0000 0100, from the input data value, i.e., b0000 0111, using Equations 2 and 3. FIG. 7G depicts the calculation of the mask (fsb) value, i.e., b0000 0010, from the input data value, i.e., b0000 0011, using Equations 2 and 3. FIG. 7H depicts the calculation of the mask (fsb) value, i.e., b0000 0001, from the input data value, i.e., b0000 0001, using Equations 2 and 3. FIG. 7I depicts the calculation of the mask (fsb) value, i.e., b0000 0000, from the input data value, i.e., b0000 0000, using Equations 2 and 3 (for completeness).

FIG. 7J depicts the calculation of the mask (fsb) value, i.e., b1010 1010, from the input data value, i.e., b1000 0000, using Equations 2 and 3. FIG. 7K depicts the calculation of the mask (fsb) value, i.e., b0100 0000, from the input data value, i.e., b0101 0101, using Equations 2 and 3. FIG. 7L depicts the calculation of the mask (fsb) value, i.e., b0010 0000, from the input data value, i.e., b0011 1100, using Equations 2 and 3.

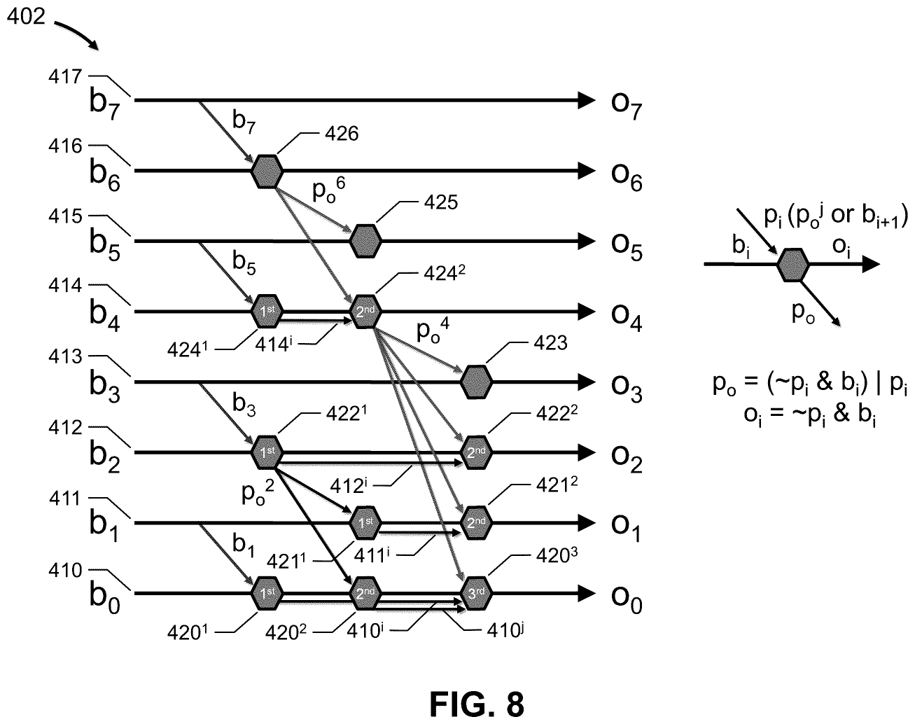

FIG. 8 depicts BPU 402, in accordance with an embodiment of the present disclosure.

As described above, BPU 402 receives an input data value, determines the first (most significant) set bit therein, and outputs a mask value that preserves the first set bit (“1”) and sets the subsequent (less significant) set bits to zero (“0”). BPU 400 includes, inter alia, bitlines 410, 411, 412, 413, 414, 415, 416 and 417, and processing nodes 420¹, 420², 420³, 421¹, 421¹, 422¹, 422¹, 423, 424¹, 424¹, 425 and 426.

In this embodiment, BPU 402 receives an 8-bit input data value over eight bitlines, and outputs an 8-bit mask value over eight bitlines. Bits b₀, b₁, b₂, b₃, b₄, b₅, b₆, and b₇ of the input data value are input over bitlines 410, 411, 412, 413, 414, 415, 416 and 417, respectively, and bits o₀, o₁, o₂, o₃, o₄, o₅, o₆ and o₇ of the mask value are output over bitlines 410, 411, 412, 413, 414, 415, 416 and 417, respectively. Bits b₀ and o₀ are the LSBs, while bits b₇ and o₇ are the MSBs.

Processing node 426 is coupled to bitline 416, bitline 417, processing node 425 and processing node 424². Processing node 425 is coupled to bitline 415 and processing node 426. Processing node 424¹ is coupled to bitline 414 and bitline 415. Processing node 424² is coupled to bitline 414 and processing nodes 426, 423, 422², 421² and 420³. Processing node 423 is coupled to bitline 413 and processing node 424². Processing node 422¹ is coupled to bitline 412 and bitline 413. Processing node 422² is coupled to bitline 412 and processing node 424². Processing node 421¹ is coupled to bitline 411 and processing node 422¹. Processing node 421² is coupled to bitline 411 and processing node 424². Processing node 420¹ is coupled to bitline 410 and bitline 411. Processing node 420² is coupled to bitline 411 and processing node 422¹. Processing node 420³ is coupled to bitline 410 and processing node 424².

In order to generate a mask of the first set bit, processing begins with bit b₇ (bitline 417) and flows down to each subsequent bitline.

For bitline 417, bit b₇ is simply output as bit o₇. When bit b₇ is set to one (“1”), o₇ is set to one (“1”) and the remaining bits o₆, o₅, o₄, o₃, o₂, o₁ and o₀ are set to zero (“0”) by processing nodes 420, 421, 422, 423, 424, 425 and 426. When bit b₇ is set to zero (“0”), o₇ is set to zero (“0”) and the remaining bits b₆, b₅, b₄, b₃, b₂, b₁ and b₀ are processed by processing nodes 420, 421, 422, 423, 424, 425 and 426 to determine the first set bit.

For bitline 416, processing node 426 receives bit b₆ from bitline 416 and bit b₇ from bitline 417, generates signal pₒ⁶ using Equation 2 and bit o₆ using Equation 3, outputs bit o₆ along bitline 416, and outputs signal pₒ⁶ to processing nodes 425 and 424².

For bitline 415, processing node 425 receives bit b5 from bitline 415 and signal pₒ⁶ from processing node 426, generates bit o₅ using Equation 3, and outputs bit o₅ along bitline 415.

For bitline 414, processing node 424¹ receives bit b₄ from bitline 414 and bit b₅ from bitline 415, generates bit o₄¹ using Equation 3, and outputs bit o₄¹ along bitline 414ⁱ to processing node 424². Processing node 424² receives bit b₄ from bitline 414 and bit o₄¹ from processing node 424¹, generates signal pₒ⁴ using Equation 2 and bit o₄² using Equation 3, combines bit o₄¹ and bit o₄² using a bitwise AND to generate bit o₄, outputs bit o₄ along bitline 414, and outputs signal pₒ⁴ to processing nodes 423, 422², 421² and 420³.

For bitline 413, processing node 423 receives bit b₃ from bitline 413 and signal pₒ⁴ from processing node 424₂, generates bit o₃ using Equation 3, and outputs bit o₃ along bitline 413.

For bitline 412, processing node 422¹ receives bit b₂ from bitline 412 and bit b₃ from bitline 413, generates signal pₒ² using Equation 2 and bit o₂¹ using Equation 3, outputs signal pₒ² to processing nodes 421¹ and 420², and outputs bit o₂¹ along bitline 412ⁱ to processing node 422². Processing node 422² receives bit b₂ from bitline 412 and bit o₂¹ from processing node 422¹, generates bit o₂² using Equation 3, combines bit o₂¹ and bit o₂² using a bitwise AND to generate bit o₂, outputs bit o₂ along bitline 414.

For bitline 411, processing node 421¹ receives bit b₁ from bitline 411 and signal pₒ² from processing node 422¹, generates bit o₁¹ using Equation 3, and outputs bit o₁¹ along bitline 411ⁱ to processing node 421². Processing node 421² receives bit b₁ from bitline 411 and bit o₁¹ from processing node 421¹, generates bit o₁² using Equation 3, combines bit o₁¹ and bit o₁² using a bitwise AND to generate bit o₁, outputs bit o₁ along bitline 414.

For bitline 410, processing node 420¹ receives bit b₀ from bitline 410 and bit b₁ from bitline 411, generates bit o₀¹ using Equation 3, and outputs bit o₀¹ along bitline 410ⁱ to processing node 420³. Processing node 420² receives bit b₀ from bitline 410 and signal pₒ² from processing node 422¹, generates bit o₀² using Equation 3, and outputs bit o₀² along bitline 410 to processing node 420³. Processing node 420³ receives bit b₀ from bitline 410, bit o₀¹ from processing node 420¹ and bit o₀² from processing node 420², generates bit o₀³ using Equation 3, combines bit o₀¹, bit o₁² and bit o₀³ using a bitwise AND to generate bit o₀, outputs bit o₀ along bitline 410.

While BPU 402 processes an 8-bit data value, such as an 8-bit activation value, other size data values are also supported by simply adding or removing bitlines and nodes.

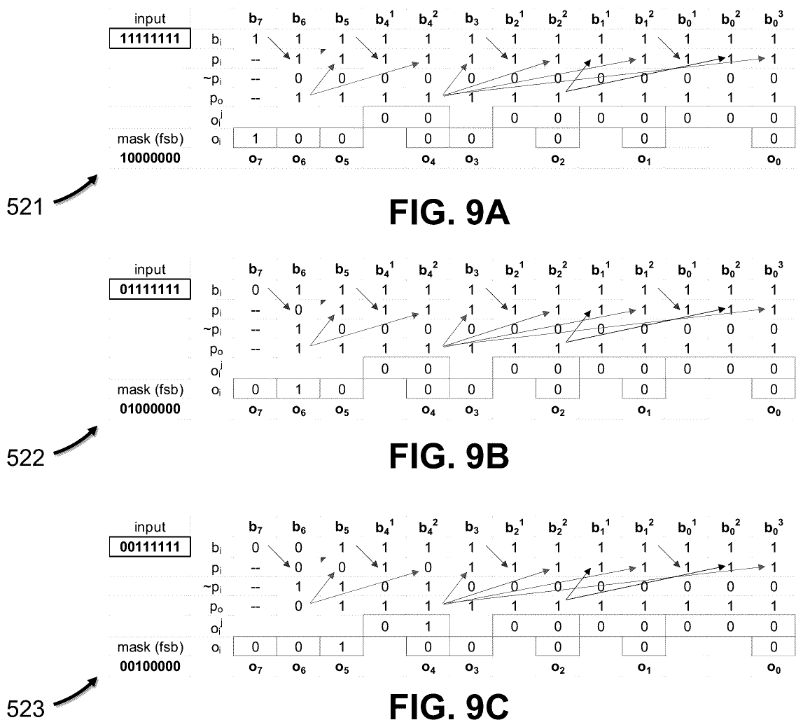

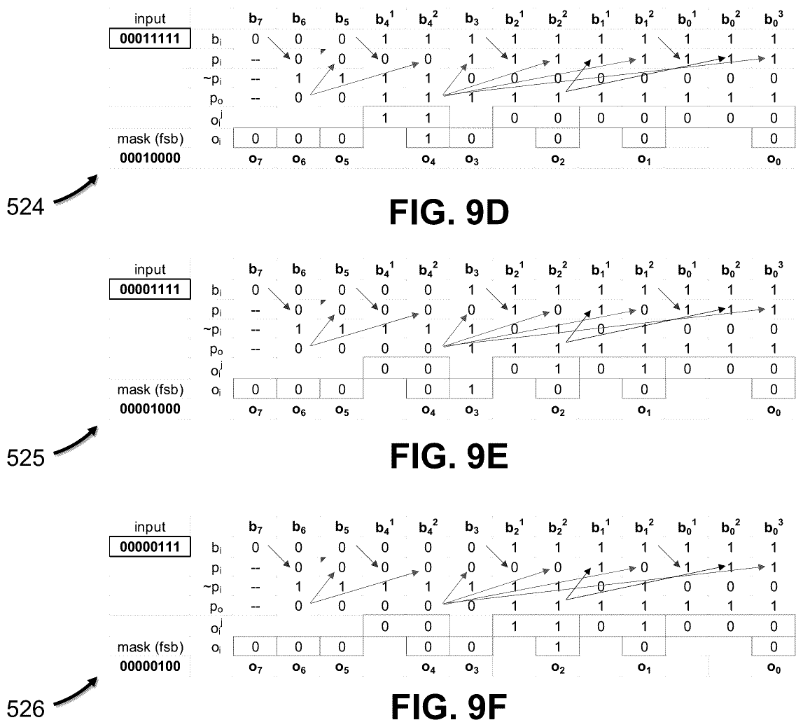

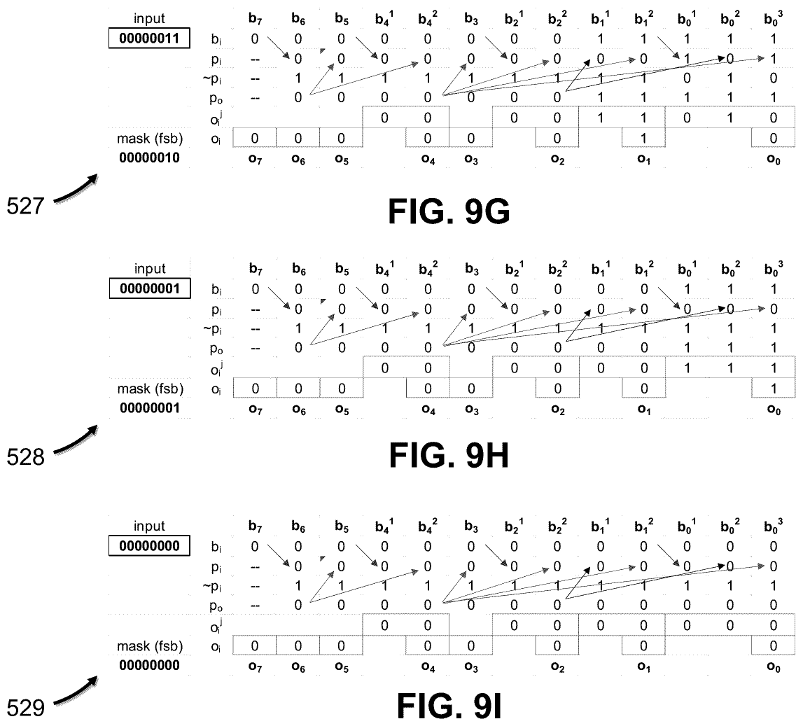

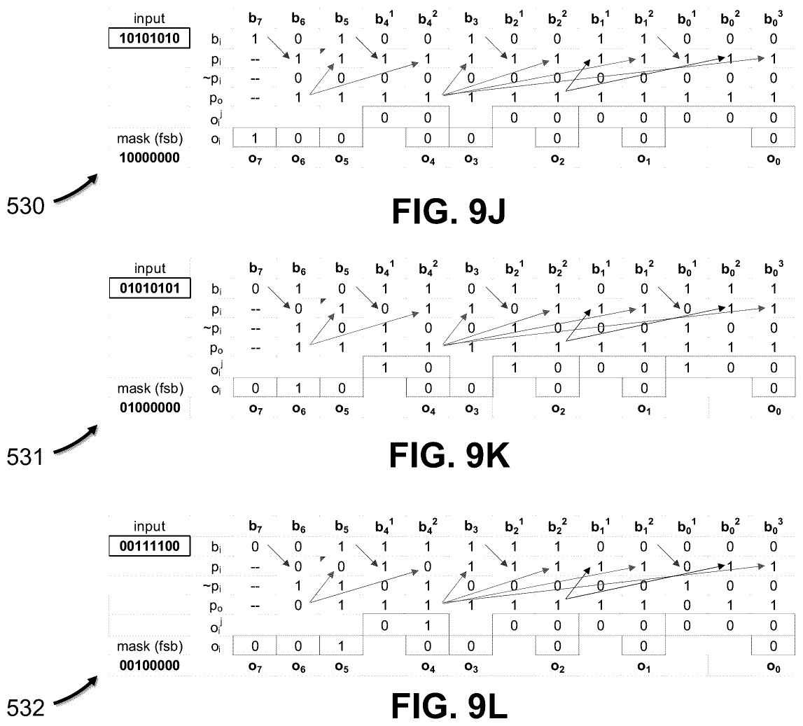

FIGS. 9A to 9L depict the generation of the mask of the first set bit for different input data values, in accordance with an embodiment of the present disclosure.

FIG. 9A depicts the calculation of the mask (first set bit or fsb) value, i.e., b1000 0000, from the input data value, i.e., b1111 1111, using Equations 2 and 3. The values of bᵢ, pᵢ, ˜pᵢ, Pₒ, oᵢ^{j} and oᵢ are depicted for each bit bᵢ, and the input value for pᵢ is indicated by an arrow for bits b₆, b₅, b₄¹ (processing node 424¹), b₄² (processing node 424²), b₃, b₂¹ (processing node 422¹), b₂² (processing node 422²), b₁¹ (processing node 421¹), b₁² (processing node 421²), b₀¹ (processing node 420¹), b₀² (processing node 420²) and b₀³ (processing node 420³).

FIG. 9B depicts the calculation of the mask (fsb) value, i.e., b0100 0000, from the input data value, i.e., b0111 1111, using Equations 2 and 3. FIG. 9C depicts the calculation of the mask (fsb) value, i.e., b0010 0000, from the input data value, i.e., b0011 1111, using Equations 2 and 3. FIG. 9D depicts the calculation of the mask (fsb) value, i.e., b0001 0000, from the input data value, i.e., b0001 1111, using Equations 2 and 3. FIG. 9E depicts the calculation of the mask (fsb) value, i.e., b0000 1000, from the input data value, i.e., b0000 1111, using Equations 2 and 3. FIG. 9F depicts the calculation of the mask (fsb) value, i.e., b0000 0100, from the input data value, i.e., b0000 0111, using Equations 2 and 3. FIG. 9G depicts the calculation of the mask (fsb) value, i.e., b0000 0010, from the input data value, i.e., b0000 0011, using Equations 2 and 3. FIG. 9H depicts the calculation of the mask (fsb) value, i.e., b0000 0001, from the input data value, i.e., b0000 0001, using Equations 2 and 3. FIG. 9I depicts the calculation of the mask (fsb) value, i.e., b0000 0000, from the input data value, i.e., b0000 0000, using Equations 2 and 3 (for completeness).

FIG. 9J depicts the calculation of the mask (fsb) value, i.e., b1010 1010, from the input data value, i.e., b1000 0000, using Equations 2 and 3. FIG. 9K depicts the calculation of the mask (fsb) value, i.e., b0100 0000, from the input data value, i.e., b0101 0101, using Equations 2 and 3. FIG. 9L depicts the calculation of the mask (fsb) value, i.e., b0010 0000, from the input data value, i.e., b0011 1100, using Equations 2 and 3.

As seen by inspection, BPUs 400 and 402 produce the same mask values for each input data value.

For small-scale neural networks directly implemented or hard-wired into silicon, a field-programmable gate array (FPGA), etc., such as, for example, tinyML applications, etc., embodiments of the present disclosure advantageously reduce silicon area and power consumption in proportion to bit density. This is possible because any bit positions with zero bits in a given weight does not require any computations at all, and, therefore, physical hardware is not needed, implemented or programmed.

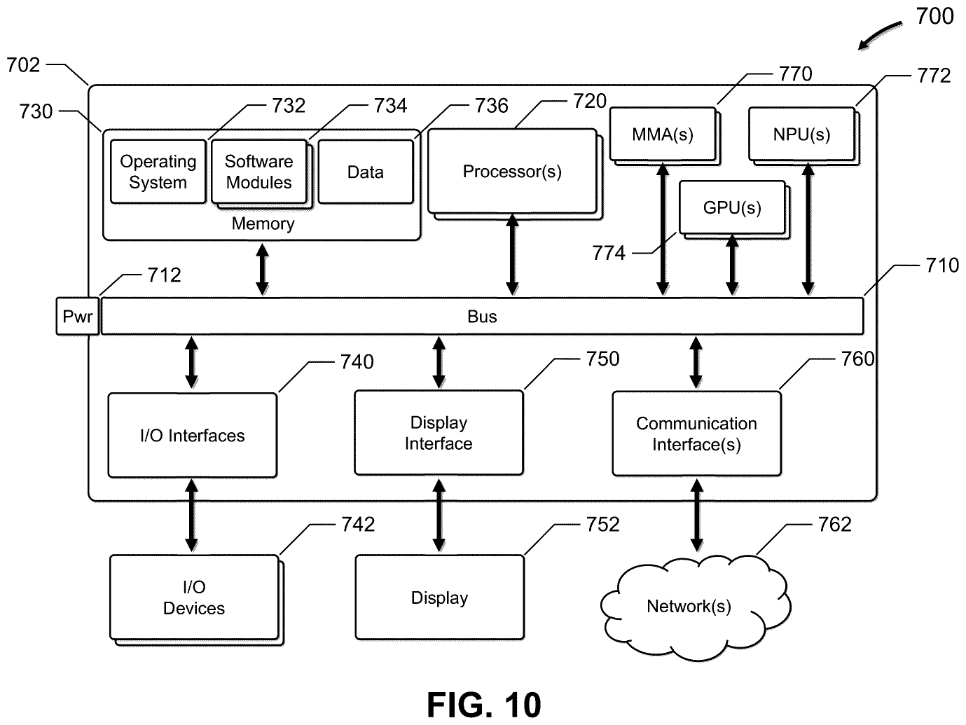

FIG. 10 depicts a block diagram of system 700, in accordance with an embodiment of the present disclosure.

System 700 executes, inter alia, the trained neural network during inference. In some embodiments, system 700 may also train the neural network; in other embodiments, one or more higher-performance computers train the neural network, such as a computer with multiple, multi-core CPUs, one or more NPUs and/or GPUs, etc.

Computer 702 includes bus 710 coupled to one or more processors 720, memory 730, I/O interfaces 740, display interface 750, and one or more communication interfaces 760. In many embodiments, computer 702 also includes one or more special processors, such as, for example, MMAs 770, NPUs 772, GPUs 774, etc. Generally, I/O interfaces 740 are coupled to I/O devices 742 using a wired or wireless connection, display interface 750 is coupled to display 752, and communication interface 760 is connected to network 762 using a wired or wireless connection.

Bus 710 is a communication system that transfers data between processor 720, memory 730, I/O interfaces 740, display interface 750, communication interface 760, MMA 770, NPU 772 and GPU 774, as well as other components not depicted in FIG. 10. Power connector 712 is coupled to bus 710 and a power supply (not shown).

Processor 720 includes one or more general-purpose or application-specific microprocessors that executes instructions to perform control, computation, input/output, etc. functions for computer 702. Processor 720 may include a single integrated circuit, such as a micro-processing device, or multiple integrated circuit devices and/or circuit boards working in cooperation to accomplish the functions of processor 720. In addition, processor 720 may execute computer programs or modules, such as operating system 732, software modules 734, etc., stored within memory 730. For example, software modules 734 may include an machine learning application, an ANN application, a CNN application, etc.

Generally, storage element or memory 730 stores instructions for execution by processor 720 and data. Memory 730 may include a variety of non-transitory computer-readable medium that may be accessed by processor 720. In various embodiments, memory 730 may include volatile and nonvolatile medium, non-removable medium and/or removable medium. For example, memory 730 may include any combination of random access memory (RAM), dynamic RAM (DRAM), static RAM (SRAM), read only memory (ROM), flash memory, cache memory, and/or any other type of non-transitory computer-readable medium.

Memory 730 contains various components for retrieving, presenting, modifying, and storing data. For example, memory 730 stores software modules that provide functionality when executed by processor 720. The software modules include operating system 732 that provides operating system functionality for computer 702. Software modules 734 provide various functionality, such as image classification using convolutional neural networks, etc. Data 736 may include data associated with operating system 732, software modules 734, etc.

I/O interfaces 740 are configured to transmit and/or receive data from I/O devices 742. I/O interfaces 740 enable connectivity between processor 720 and I/O devices 742 by encoding data to be sent from processor 720 to I/O devices 742, and decoding data received from I/O devices 742 for processor 720. Generally, data may be sent over wired and/or wireless connections. For example, I/O interfaces 740 may include one or more wired communications interfaces, such as USB, Ethernet, etc., and/or one or more wireless communications interfaces, coupled to one or more antennas, such as WiFi, Bluetooth, cellular, etc.

Generally, I/O devices 742 provide input to computer 702 and/or output from computer 702. As discussed above, I/O devices 742 are operably connected to computer 702 using a wired and/or wireless connection. I/O devices 742 may include a local processor coupled to a communication interface that is configured to communicate with computer 702 using the wired and/or wireless connection. For example, I/O devices 742 may include a keyboard, mouse, touch pad, joystick, etc.

Display interface 750 is configured to transmit image data from computer 702 to monitor or display 752.

Communication interface 760 is configured to transmit data to and from network 762 using one or more wired and/or wireless connections. Network 762 may include one or more local area networks, wide area networks, the Internet, etc., which may execute various network protocols, such as, for example, wired and/or wireless Ethernet, Bluetooth, etc. Network 762 may also include various combinations of wired and/or wireless physical layers, such as, for example, copper wire or coaxial cable networks, fiber optic networks, Bluetooth wireless networks, WiFi wireless networks, CDMA, FDMA and TDMA cellular wireless networks, etc.

MMA 770 is configured to multiply matrices and generate output matrices to support various applications implemented by software modules 734, such as, for example, machine learning applications, artificial neural network applications, etc. Similarly, NPU 772 and GPU 774 are generally configured, inter alia, to execute at least a portion of an artificial neural network to support various applications implemented by software modules 734.

As described above, weight data are quantized and bit-pruned during neural network training and the resulting weights are used during inference. In many embodiments, activation data are also quantized and bit-pruned during neural network training, and then dynamically quantized and bit-pruned during inference.

During inference, input data are provided to the trained neural network, which generates at least one prediction. In many embodiments, the input data is sensor data, and the prediction(s) are provided as input data to an autonomous or semi-autonomous process, such as, for example, a navigation and control process for a vehicle, airplane, ship, etc., a traffic prediction and control process, a robotic surgical process, an image recognition process, a speech recognition process, a language translation process, etc. The sensor data are environmental or other data collected by sensors or subsystems coupled to the inference computer, or provided to the inference computer through one or more communication channels. The sensor data may include, for example, camera image data, microphone audio data, accelerometer data, micro-electromechanical system (MEMS) sensor data, light detection and ranging (LIDAR) data, global positioning system (GPS) data, robot element (i.e., arm, joint, finger, etc.) position, velocity and acceleration data, etc.

The embodiments described herein are combinable.

In one embodiment, a method includes training a neural network, based on training data, to generate a trained neural network, the neural network including weights, the training including quantizing the weights to generate quantized weights, each quantized weight including a number of bits set to 1, and pruning, based on the number of bits set to 1, the quantized weights to generate bit-pruned weights, each bit pruned weight including a smaller number of bits set to 1 than the respective quantized weight, where the trained neural network includes the bit-pruned weights.

In another embodiment of the method, the method further includes executing the trained neural network, based on input data, to generate at least one prediction.

In another embodiment of the method, pruning the quantized weights includes for each quantized weight: replacing each sequence of N consecutive bits set to 1 with a sequence of N consecutive bits set to zero, and setting the bit in the next highest bit position relative to each sequence of N consecutive bits to 1; and N is greater than 1.

In another embodiment of the method, pruning the quantized weights includes, for each quantized weight, reducing the number of bits set to 1 to N; and N is greater than 0.

In another embodiment of the method, pruning the quantized weights includes: determining an average number of the bits set to 1 in the quantized weights, and reducing the number of the bits set to 1 in each quantized weight to reduce an average number of bits set to 1 to N; and N is greater than zero.

In another embodiment of the method, training the neural network and executing the trained neural network include: quantizing activations to generate quantized activations, each quantized activation including a number of bits set to 1; and pruning, based on the number of bits set to 1, the quantized activations to generate bit-pruned activations, each bit pruned activation including a smaller number of bits set to 1 than the respective quantized activation.

In another embodiment of the method, pruning the quantized activations includes for each quantized activation: replacing each sequence of N consecutive bits set to 1 with a sequence of N consecutive bits set to zero, and setting the bit in the next highest bit position relative to each sequence of N consecutive bits to 1; and N is greater than 1.

In another embodiment of the method, pruning the quantized activations includes, for each quantized activation, reducing the number of bits set to 1 to N; and N is greater than 0.

In another embodiment of the method, pruning the quantized activations includes: determining an average number of the bits set to 1 in the quantized activation, and reducing the number of the bits set to 1 in each quantized activation to reduce an average number of bits set to 1 to N; and N is greater than zero.

In another embodiment of the method, the input data is sensor data, and the method further comprises executing an autonomous or semi-autonomous process based, at least in part, on the prediction.

In one embodiment, a system includes processing circuitry configured to: execute, based on input data, a neural network to generate at least one prediction, the neural network including bit-pruned weights, said execute including: quantize activations to generate quantized activations, each quantized activation including a number of bits set to 1, and prune, based on the number of bits set to 1, the quantized activations to generate bit-pruned activations, each bit-pruned activation including a smaller number of bits set to 1 than the respective quantized activation.

In another embodiment of the system, the processing circuitry includes a plurality of bit-pruning units (BPUs), and each BPU is configured to prune a quantized activation.

In another embodiment of the system, prune the quantized activations includes for each quantized activation: replace each sequence of N consecutive bits set to 1 with a sequence of N consecutive bits set to zero, and set the bit in the next highest bit position relative to each sequence of N consecutive bits to 1; and N is greater than 1.

In another embodiment of the system, prune the quantized activations includes, for each quantized activation, reduce the number of bits set to 1 to N; and N is greater than 0.

In another embodiment of the system, prune the quantized activations includes: determine an average number of the bits set to 1 in the quantized activation, and reduce the number of the bits set to 1 in each quantized activation to reduce an average number of bits set to 1 to N; and N is greater than zero.

In another embodiment of the system, the system further includes at least one sensor, coupled to the processing circuitry, configured to generate and transmit sensor data to the processing circuitry, and the processing circuitry is further configured to execute an autonomous or semi-autonomous process based, at least in part, on the prediction.

In one embodiment, a bit-pruning unit (BPU) includes a plurality of bitlines, including a most significant bitline and a number of less significant bitlines, each bitline configured to receive a different bit of an input data value; and a plurality of processing nodes, at least one processing node coupled to each less significant bitline, each processing node configured to: receive a first input bit from the respective less significant bitline, receive a second input bit from a more significant bitline or a processing node coupled to a more significant bitline, and generate, based on the first and second input bits, an output bit, where the output bits from the processing nodes form a mask value that identifies a first set bit of the input data value.

In another embodiment of the BPU, one or more processing nodes are configured to: generate, based on the first and second input bits, the second input bit for one or more processing nodes coupled to less significant bitlines.

In another embodiment of the BPU, each less significant bitline is coupled to one processing node; the second input of a first processing node is coupled to the most significant bitline; and the second input of each remaining processing node is coupled to the processing node coupled to an immediately more significant bitline.

In another embodiment of the BPU, a first portion of the less significant bitlines are coupled to a single processing node; a second portion of the less significant bitlines are coupled to two processing nodes; and a third portion of the less significant bitlines are coupled to three processing nodes.

In another embodiment of the BPU, the BPU is one of a cascade of N BPUs that are configured to identify the N most significant set bits of the input data value.

In another embodiment of the BPU, a first intermediate input data value has the first set bit of the input data value set to zero; each bitline is configured to receive a different bit of the first intermediate input data value; and the output bits from the processing nodes form an intermediate mask value that identifies a second set bit of the input data value.

In another embodiment of the BPU, N−1 intermediate mask values identify N−1 significant set bits of the input data value based on N−1 intermediate input data values; and the mask value and the N−1 intermediate mask values are combined to form a final mask value that identifies the N most significant set bits of the input data value.

While implementations of the disclosure are susceptible to embodiment in many different forms, there is shown in the drawings and will herein be described in detail specific embodiments, with the understanding that the present disclosure is to be considered as an example of the principles of the disclosure and not intended to limit the disclosure to the specific embodiments shown and described. In the description above, like reference numerals may be used to describe the same, similar or corresponding parts in the several views of the drawings.

In this document, relational terms such as first and second, top and bottom, and the like may be used solely to distinguish one entity or action from another entity or action without necessarily requiring or implying any actual such relationship or order between such entities or actions. The terms “comprises,” “comprising,” “includes,” “including,” “has,” “having,” or any other variations thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

Reference throughout this document to “one embodiment,” “certain embodiments,” “an embodiment,” “implementation(s),” “aspect(s),” or similar terms means that a particular feature, structure, or characteristic described in connection with the embodiment is included in at least one embodiment of the present disclosure. Thus, the appearances of such phrases or in various places throughout this specification are not necessarily all referring to the same embodiment. Furthermore, the particular features, structures, or characteristics may be combined in any suitable manner in one or more embodiments without limitation.

The term “or” as used herein is to be interpreted as an inclusive or meaning any one or any combination. Therefore, “A, B or C” means “any of the following: A; B; C; A and B; A and C; B and C; A, B and C.” An exception to this definition will occur only when a combination of elements, functions, steps or acts are in some way inherently mutually exclusive. Also, grammatical conjunctions are intended to express any and all disjunctive and conjunctive combinations of conjoined clauses, sentences, words, and the like, unless otherwise stated or clear from the context. Thus, the term “or” should generally be understood to mean “and/or” and so forth. References to items in the singular should be understood to include items in the plural, and vice versa, unless explicitly stated otherwise or clear from the text.

Recitation of ranges of values herein are not intended to be limiting, referring instead individually to any and all values falling within the range, unless otherwise indicated, and each separate value within such a range is incorporated into the specification as if it were individually recited herein. The words “about,” “approximately,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the described embodiments. The use of any and all examples, or exemplary language (“e.g.,” “such as,” “for example,” or the like) provided herein, is intended merely to better illuminate the embodiments and does not pose a limitation on the scope of the embodiments. No language in the specification should be construed as indicating any unclaimed element as essential to the practice of the embodiments.

For simplicity and clarity of illustration, reference numerals may be repeated among the figures to indicate corresponding or analogous elements. Numerous details are set forth to provide an understanding of the embodiments described herein. The embodiments may be practiced without these details. In other instances, well-known methods, procedures, and components have not been described in detail to avoid obscuring the embodiments described. The description is not to be considered as limited to the scope of the embodiments described herein.

In the following description, it is understood that terms such as “first,” “second,” “top,” “bottom,” “up,” “down,” “above,” “below,” and the like, are words of convenience and are not to be construed as limiting terms. Also, the terms apparatus, device, system, etc. may be used interchangeably in this text.

The many features and advantages of the disclosure are apparent from the detailed specification, and, thus, it is intended by the appended claims to cover all such features and advantages of the disclosure which fall within the scope of the disclosure. Further, since numerous modifications and variations will readily occur to those skilled in the art, it is not desired to limit the disclosure to the exact construction and operation illustrated and described, and, accordingly, all suitable modifications and equivalents may be resorted to that fall within the scope of the disclosure.

What is claimed is:

1. A method, comprising:
training a neural network, based on training data, to generate a trained neural network, the neural network including weights, the training including:
quantizing the weights to generate quantized weights, each quantized weight including a number of bits set to 1, and
pruning, based on the number of bits set to 1, the quantized weights to generate bit-pruned weights, each bit-pruned weight including a smaller number of bits set to 1 than the respective quantized weight,
where the trained neural network includes the bit-pruned weights.

2. The method according to claim 1, where:
said pruning the quantized weights includes for each quantized weight:
replacing each sequence of N consecutive bits set to 1 with a sequence of N consecutive bits set to zero, and
setting the bit in the next highest bit position relative to each sequence of N consecutive bits to 1; and
N is greater than 1.

3. The method according to claim 1, where:
said pruning the quantized weights includes, for each quantized weight, reducing the number of bits set to 1 to N; and
N is greater than 0.

4. The method according to claim 1, where:
said pruning the quantized weights includes:
determining an average number of the bits set to 1 in the quantized weights, and
reducing the number of the bits set to 1 in each quantized weight to reduce an average number of bits set to 1 to N; and
N is greater than zero.

5. The method according to claim 1, where said training the neural network includes:
quantizing activations to generate quantized activations, each quantized activation including a number of bits set to 1; and
pruning, based on the number of bits set to 1, the quantized activations to generate bit-pruned activations, each bit-pruned activation including a smaller number of bits set to 1 than the respective quantized activation.

6. The method according to claim 5, where:
said pruning the quantized activations includes for each quantized activation:
replacing each sequence of N consecutive bits set to 1 with a sequence of N consecutive bits set to zero, and
setting the bit in the next highest bit position relative to each sequence of N consecutive bits to 1; and
N is greater than 1.

7. The method according to claim 5, where:
said pruning the quantized activations includes, for each quantized activation, reducing the number of bits set to 1 to N; and
N is greater than 0.

8. The method according to claim 5, where:
said pruning the quantized activations includes:
determining an average number of the bits set to 1 in the quantized activation, and
reducing the number of the bits set to 1 in each quantized activation to reduce an average number of bits set to 1 to N; and
N is greater than zero.

9. The method according to claim 1, further comprising:
executing the trained neural network, based on input data from one or more sensors, to generate at least one prediction, including:
quantizing activations to generate quantized activations, each quantized activation including a number of bits set to 1, and
pruning, based on the number of bits set to 1, the quantized activations to generate bit-pruned activations, each bit pruned activation including a smaller number of bits set to 1 than the respective quantized activation; and
executing an autonomous or semi-autonomous process based, at least in part, on the prediction.

10. A system, comprising:
processing circuitry configured to:
execute, based on input data, a neural network to generate at least one prediction, the neural network including bit-pruned weights, said execute including:
quantize activations to generate quantized activations, each quantized activation including a number of bits set to 1, and
prune, based on the number of bits set to 1, the quantized activations to generate bit-pruned activations, each bit-pruned activation including a smaller number of bits set to 1 than the respective quantized activation.

11. The system according to claim 10, where the processing circuitry includes a plurality of bit-pruning units (BPUs), and each BPU is configured to prune a quantized activation.

12. The system according to claim 11, where:
said prune the quantized activations includes for each quantized activation:
replace each sequence of N consecutive bits set to 1 with a sequence of N consecutive bits set to zero, and
set the bit in the next highest bit position relative to each sequence of N consecutive bits to 1; and
N is greater than 1.

13. The system according to claim 11, where:
said prune the quantized activations includes, for each quantized activation, reduce the number of bits set to 1 to N; and
N is greater than 0.

14. The system according to claim 11, where:
said prune the quantized activations includes:
determine an average number of the bits set to 1 in the quantized activation, and
reduce the number of the bits set to 1 in each quantized activation to reduce an average number of bits set to 1 to N; and
N is greater than zero.

15. The system according to claim 10, further comprising:
at least one sensor, coupled to the processing circuitry, configured to generate and transmit sensor data to the processing circuitry,
where the processing circuitry is further configured to execute an autonomous or semi-autonomous process based, at least in part, on the prediction.

16. A bit-pruning unit (BPU), comprising:
a plurality of bitlines, including a most significant bitline and a number of less significant bitlines, each bitline configured to receive a different bit of an input data value; and
a plurality of processing nodes, at least one processing node coupled to each less significant bitline, each processing node configured to:
receive a first input bit from the respective less significant bitline,
receive a second input bit from a more significant bitline or a processing node coupled to a more significant bitline, and
generate, based on the first and second input bits, an output bit,
where the output bits from the processing nodes form a mask value that identifies a first set bit of the input data value.

17. The BPU according to claim 16, where:
one or more processing nodes are configured to generate, based on the first and second input bits, the second input bit for one or more processing nodes coupled to less significant bitlines;
each less significant bitline is coupled to one processing node;
the second input of a first processing node is coupled to the most significant bitline; and
the second input of each remaining processing node is coupled to the processing node coupled to an immediately more significant bitline.

18. The BPU according to claim 16, where:
one or more processing nodes are configured to generate, based on the first and second input bits, the second input bit for one or more processing nodes coupled to less significant bitlines;
a first portion of the less significant bitlines are coupled to a single processing node;
a second portion of the less significant bitlines are coupled to two processing nodes; and
a third portion of the less significant bitlines are coupled to three processing nodes.

19. The BPU according to claim 16, where:
the BPU is one of a cascade of N BPUs that are configured to identify the N most significant set bits of the input data value.

20. The BPU according to claim 16, where:
a first intermediate input data value has the first set bit of the input data value set to zero;
each bitline is configured to receive a different bit of the first intermediate input data value;
the output bits from the processing nodes form an intermediate mask value that identifies a second set bit of the input data value;
N−1 intermediate mask values identify N−1 significant set bits of the input data value based on N−1 intermediate input data values; and
the mask value and the N−1 intermediate mask values are combined to form a final mask value that identifies the N most significant set bits of the input data value.
